(19) United States
(12) Patent Application Publication
(10) Pub. No.: US 2008/0318449 A1
(43) Pub. Date: Dec. 25, 2008

(54) MULTI-LEVEL CELL (MLC) DUAL PERSONALITY EXTENDED eSATA FLASH MEMORY DEVICE

(75) Inventors: Abraham Ma, Fremont, CA (US); I-Kang Yu, Palo Alto, CA (US); David Nguyen, San Jose, CA (US); Charles C. Lee, Cupertino, CA (US); Ming-Shiang Shen, Taipei Hsien (TW)

Correspondence Address: LAW OFFICES OF IMAM, 111 N. MARKET STREET, SUITE 1010, SAN JOSE, CA, 95113, US

(73) Assignee: SUPER TALENT ELECTRONICS, INC., San Jose, CA (US)

(21) Appl. No.: 12/113,023

(22) Filed: Apr. 30, 2008

Related U.S. Application Data
(63) Continuation-in-part of application No. 12/099,421, filed on Apr. 8, 2008.
Application No. 12/099,421 is a continuation-in-part of application No. 11/076,514, filed on Mar. 8, 2005, now Pat. No. 7,393,247.
Application No. 11/076,514 is a continuation-in-part of application No. 10/854,004, filed on May 25, 2004.
Application No. 10/854,004 is a continuation-in-part of application No. 10/708,172, filed on Feb. 12, 2004, now Pat. No. 7,021,971.
Application No. 10/708,172 is a continuation-in-part of application No. 11/866,927, filed on Oct. 3, 2007.
Application No. 11/866,927 is a continuation-in-part of application No. 11/845,747, filed on Aug. 27, 2007.
Application No. 11/845,747 is a continuation-in-part of application No. 11/929,857, filed on Oct. 30, 2007.
Application No. 11/929,857 is a continuation-in-part of application No. 11/864,696, filed on Sep. 28, 2007.
Application No. 11/864,696 is a continuation-in-part of application No. 11/624,667, filed on Jan. 18, 2007.
Application No. 11/624,667 is a division of application No. 09/478,720, filed on Jan. 6, 2000, now Pat. No. 7,257,714.
Application No. 09/478,720 is a continuation-in-part of application No. 09/366,976, filed on Aug. 4, 1999, now Pat. No. 6,547,130.

(51) Int. Cl. H01R 24/00; H01R 12/00; G06K 9/00

(52) U.S. Cl. 439/78; 439/660; 382/124

(57) ABSTRACT

A multi-level cell (MLC) dual-personality extended External Serial Advanced Technology Attachment (eSATA) flash drive includes a MLC dual-personality extended eSATA plug connector connected to a flash drive and removably connectable to a host. The connector is adaptable to receive electoral data from both a USB and eSATA interface.

### CROSS-REFERENCE TO RELATED APPLICATIONS

This application is a continuation-in-part (CIP) of co-pending U.S. patent application for “Flash Memory Devices with Security Features”, Ser. No. 12/099,421, filed Apr. 8, 2008 which is a continuation-in-part (CIP) of co-pending U.S. patent application for “Methods and Systems of Managing Memory Addresses in a Large Capacity Multi-Level Cell (MLC) based flash memory device”, Ser. No. 12/025,706, filed Feb. 4, 2008.

This application is also a CIP of U.S. patent application for “Electronic data Flash Card with Various Flash Memory Cells”, Ser No. 11/864,671, filed Sep. 28, 2007 and U.S. patent application for “System and Method for Controlling Flash Memory”, Ser. No. 10/789,333, filed Feb. 26, 2004.

This application is also a continuation-in-part (CIP) of co-pending U.S. patent application for “Data security for Electronic Data Flash Card”, Ser. No. 11/685,143, filed on Mar. 12, 2007, which is a CIP of U.S. patent application for “System and Method for Providing Security to a Portable Storage Device”, Ser. No. 11/377,235, filed on Mar. 15, 2006.

This application is also a CIP of co-pending U.S. patent application for “Backward Compatible Extended USB Plug and Receptacle with Dual Personality”, Ser. No. 11/864,696, filed Sep. 28, 2007, which is a CIP of U.S. patent application for “Electronic Data Storage Medium with Fingerprint Verification Capability”, Ser. No. 11/624,667, filed Jan. 18, 2007, which is a divisional application of U.S. patent application Ser. No. 09/478,720, filed Jan. 6, 2000, now U.S. Pat. No. 7,257,714 issued on Aug. 14, 2007, which has been petitioned to claim the benefit of CIP status of one of inventor's earlier U.S. patent application for “Integrated Circuit Card with Fingerprint Verification Capability”, Ser. No. 09/366,976, filed on Aug. 4, 1999, now issued as U.S. Pat. No. 6,547,130.

This application is also a CIP of U.S. patent application for “Extended Secure-Digital (SD) Devices and Hosts”, Ser No. 10/854,004, filed May 25, 2004, which is a CIP of U.S. patent application for “Dual-Personality Extended USB Plug and Receptacle with PCI-Express or Serial-At-Attachment extensions, Ser. No. 10/708,172, filed Feb. 12, 2004, now issued as U.S. Pat. No. 7,021,971.

This application is also a CIP of co-pending U.S. patent application for “Extended USB Plug, USB PCBA, and USB Flash Drive with Dual-Personality”, Ser. No. 11/866,927, filed Oct. 3, 2007, and U.S. patent application for “Press/Push USB Flash Drive with Deploying and Retracting Functionalities with Elasticity Material and Fingerprint Verification Capability”, Ser. No. 11/845,747, filed Aug. 27, 2007, and U.S. patent application for “Universal Serial Bus (USB) Flash Drive having Locking Pins and Locking Grooves for Locking Swivel Cap”, Ser. No. 11/929,857, filed Oct. 30, 2007.

### FIELD OF THE INVENTION

The invention relates to flash memory devices, more particularly to systems and methods of managing memory addresses in a large capacity multi-level cell (MLC) based flash memory device.

### BACKGROUND OF THE INVENTION

As flash memory technology becomes more advanced, flash memory is replacing traditional magnetic disks as storage media for mobile systems. Flash memory has significant advantages over floppy disks or magnetic hard disks such as having high-G resistance and low power dissipation. Because of the smaller physical size of flash memory, they are also more conducive to mobile systems. Accordingly, the flash memory trend has been growing because of its compatibility with mobile systems and low-power feature. However, advances in flash technology have created a greater variety of flash memory device types that vary for reasons of performance, cost and capacity. As such, a problem arises when mobile systems that are designed for one type of flash memory are constructed using another, incompatible type of flash memory.

New generation personal computer (PC) card technologies have been developed that combine flash memory with architecture that is compatible with the Universal Serial Bus (USB) standard. This has further fueled the flash memory trend because the USB standard is easy to implement and is popular with PC users. In addition, flash memory is replacing floppy disks because flash memory provides higher storage capacity and faster access speeds than floppy drives.

In addition to the limitations introduced by the USB standard, there are inherent limitations with flash memory. First, flash memory sectors that have already been programmed must be erased before being reprogrammed. Also, flash memory sectors have a limited life span; i.e., they can be erased only a limited number of times before failure. Accordingly, flash memory access is slow due to the erase-before-write nature and ongoing erasing will damage the flash memory sectors over time.

To address the speed problems with USB-standard flash memory, hardware and firmware utilize existing small computer systems interface (SCSI) protocols so that flash memory can function as mass-storage devices similarly to magnetic hard disks. SCSI protocols have been used in USB-standard mass-storage devices long before flash memory devices have been widely adopted as storage media. Accordingly, the USB standard has incorporated traditional SCSI protocols to manage flash memory.

As the demands for larger capacity storage increase, the flash memory device needs to keep up. Instead of using single-level cell flash memory, which stores one-bit of information per cell, multi-level cell (MLC) flash memory is used. The MLC flash memory allows at least two bits per cell. However, there are a number of problems associated with the MLC flash memory. First, the MLC flash memory has a low reliability. Secondly, the MLC flash memory data programming rules require writing to an ascending page in the same block or writing to a blank new page if there are data existed in the original page. Finally, a larger capacity requires a large logical-to-physical address look up table. In the prior art approach, the size look up table is in direct portion with the capacity of the flash memory. This creates a huge problem not only to the cost, but also to the physical size of the flash memory device. Furthermore, the traditional usage of the flash memory devices is generally in a very clean and relatively mild environment, thus the packaging design such as enclosure of the flash memory device is not suitable for hostile environment such as military and heavy industrial applications.

Therefore, it would be desirable to have improved methods and systems of managing memory addresses in a large capacity multi-level cell (MLC) flash memory device.

### BRIEF SUMMARY OF THE INVENTION

Briefly, a dual-personality extended External Serial Advanced Technology Attachment (eSATA) flash drive is disclosed to include a dual-personality extended eSATA plug connector. The flash memory device with MLC compatible is being removably connectable to a host thru a dual-personality extended eSATA receptacle connector. Both plug and receptacle connectors have SATA interface with 7 standard pins along with the extended USB interface with 4 standard pins.

In an alternative embodiment, the MLC flash memory device that is used with a USB connector could be replaced with eSATA connector which has more pins, for example 7 instead of 4 as a USB connector.

These and other objects and advantages of the present invention will no doubt become apparent to those skilled in the art after having read the following detailed description of the preferred embodiments illustrated in the several figures of the drawing.

### BRIEF DESCRIPTION OF THE DRAWINGS

These and other features, aspects, and advantages of the present invention will be better understood with regard to the following description, appended claims, and accompanying drawings as follows:

FIGS. 1A-1C are block diagrams showing three electronic environments, in which one embodiment of the present invention may be implemented in three respective exemplary electronic flash memory devices;

FIG. 2A is a diagram depicting a data structure of an exemplary large capacity flash memory, according one embodiment of the present invention;

FIG. 2B is a diagram showing an exemplary scheme for partitioning a logical sector address in accordance with one embodiment of the present invention;

FIG. 3 is a simplified block diagram illustrating salient components of an exemplary processing unit of each of the electronic flash memory devices of FIGS. 1A-1C, according to an embodiment of the present invention;

FIGS. 4A-4F collectively show exemplary data structures used for managing memory addresses of the flash memory of FIG. 2A in accordance with one embodiment of the present invention;

FIGS. 5A-5E collectively show a flow chart of an exemplary process of conducting data transfer requests of the flash memory of FIG. 2A in accordance with one embodiment of the present invention;

FIGS. 6A-6E collectively show a sequence of data write requests to demonstrate the exemplary process 500 of FIGS. 5A-5E;

FIGS. 7A-7E collectively are a flowchart illustrating an exemplary process of initialization of a large capacity flash memory device in accordance with one embodiment of the present invention; and

FIGS. 8(a)-8(z) collectively show various perspective views and exploded perspective views of exemplary flash memory devices in accordance with several embodiments of the present invention.

### DETAILED DESCRIPTION

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Used herein, the terms “upper”, “lower”, “top”, “bottom”, “front”, “back”, “rear”, “side”, “middle”, “upwards”, and “downwards” are intended to provide relative positions for the purposes of description, and are not intended to designate an absolute frame of reference. Further, the order of blocks in process flowcharts or diagrams representing one or more embodiments of the invention do not inherently indicate any particular order nor imply any limitations in the invention.

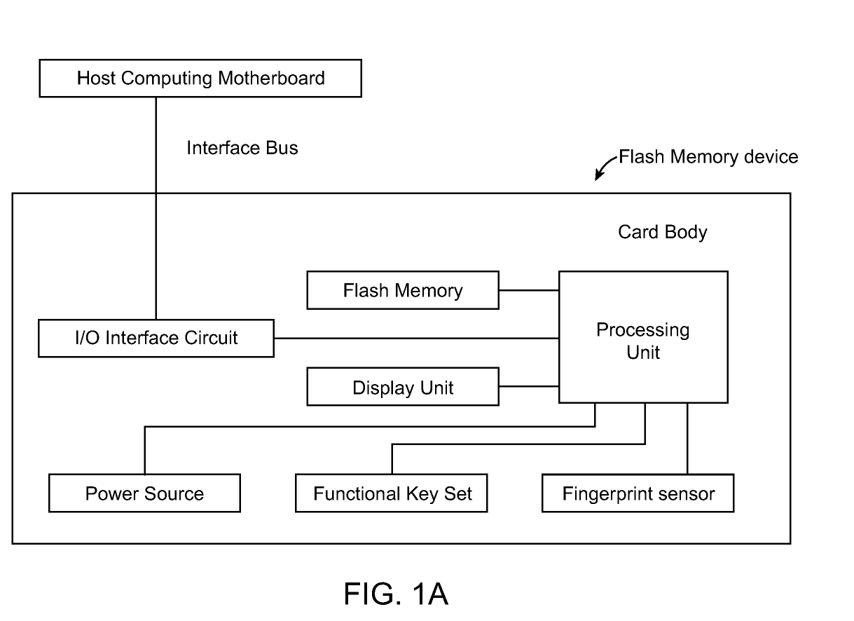

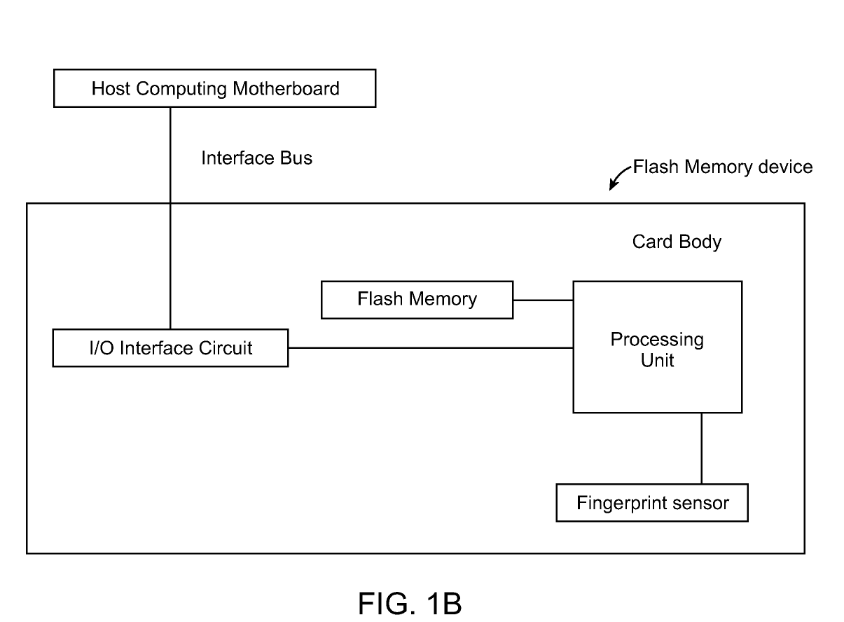

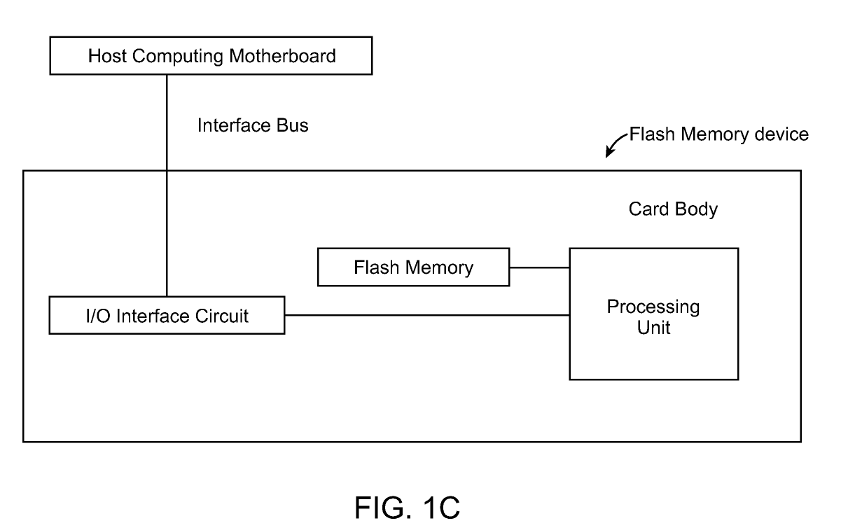

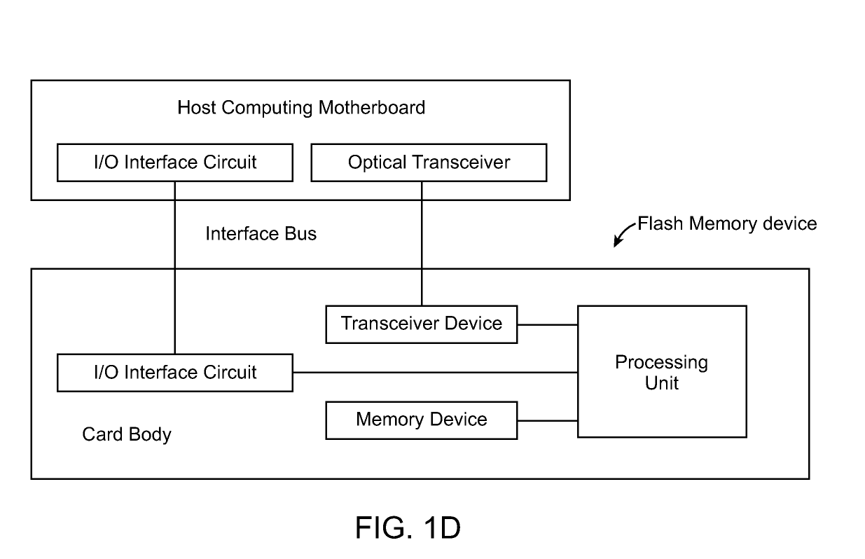

Embodiments of the present invention are discussed herein with reference to FIGS. 1A-8(z). However, those skilled in the art will readily appreciate that the detailed description given herein with respect to these figures is for explanatory purposes as the invention extends beyond these limited embodiments.

FIGS. 1A-1C are block diagrams illustrating three electronic environments, in which one embodiment of the present invention may be deployed in three respective exemplary electronic flash memory devices. Shown in FIG. 1A is a first electronic environment. A first flash memory device is adapted to be accessed by a host computing motherboard via an interface bus. The first flash memory device includes a card body, a processing unit, at least one flash memory module, a fingerprint sensor, an input/output (I/O) interface circuit, an optional display unit, an optional power source (e.g., battery), and an optional function key set. The host computing motherboard may include, but not be limited to, a desktop computer, a laptop computer, a cellular phone, a digital camera, a digital camcorder, a personal multimedia player.

The card body is configured for providing electrical and mechanical connection for the processing unit, the flash memory module, the I/O interface circuit, and all of the optional components. The card body may comprise a printed circuit board (PCB) or an equivalent substrate such that all of the components as integrated circuits may be mounted thereon. The substrate may be manufactured using surface mount technology (SMT) or chip on board (COB) technology.

The processing unit and the I/O interface circuit are collectively configured to provide various control functions (e.g., data read, write and erase transactions) of the flash memory module. The processing unit may also be a standalone microprocessor or microcontroller, for example, an 8051, 8052, or 80286 Intel® microprocessor, or ARM®, MIPS® or other equivalent digital signal processor. The processing unit and the I/O interface circuit may be made in a single integrated circuit, for application specific integrated circuit (ASIC).

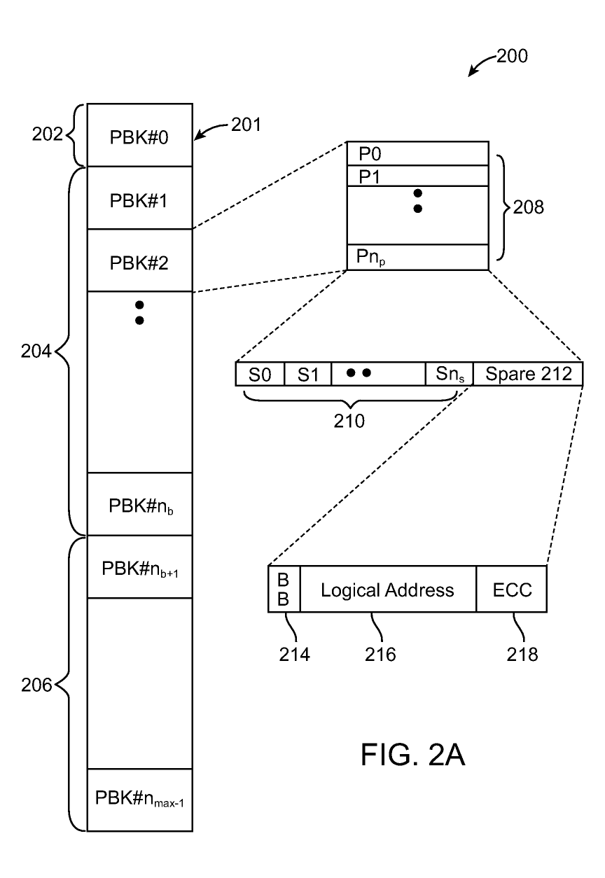

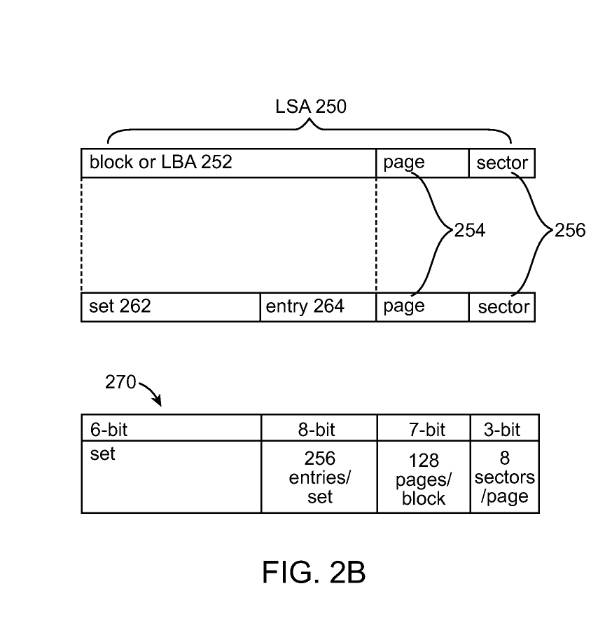

The at least one flash memory module may comprise one or more flash memory chips or integrated circuits. The flash memory chips may be single-level cell (SLC) or multi-level cell (MLC) based. In SLC flash memory, each cell holds one bit of information, while more than one bit (e.g., 2, 4 or more bits) are stored in a MLC flash memory cell. A detail data structure of an exemplary flash memory is described and shown in FIG. 2A and corresponding descriptions thereof.

The fingerprint sensor is mounted on the card body, and is adapted to scan a fingerprint of a user of the first electronic flash memory device to generate fingerprint scan data. Details of the fingerprint sensor are shown and described in a co-inventor's U.S. patent application Ser. No. 12/099,421, entitled “Flash Memory Devices with Security Features” filed on Apr. 8, 2008, the entire content of which is incorporated herein by reference.

The flash memory module stores, in a known manner therein, one or more data files, a reference password, and the fingerprint reference data obtained by scanning a fingerprint of one or more authorized users of the first flash memory device. Only authorized users can access the stored data files. The data file can be a picture file, a text file or any other file. Since the electronic data storage compares fingerprint scan data obtained by scanning a fingerprint of a user of the device with the fingerprint reference data in the memory device to verify if the user is the assigned user, the electronic data storage can only be used by the assigned user so as to reduce the risks involved when the electronic data storage is stolen or misplaced.

The input/output interface circuit is mounted on the card body, and can be activated so as to establish communication with the host computing motherboard by way of an appropriate socket via an interface bus. The input/output interface circuit may include circuits and control logic associated with an External Serial Advanced Technology Attachment (eSATA) interface structure that is connectable to an associated socket connected to or mounted on the host computing motherboard.

The processing unit is controlled by a software program module (e.g., a firmware (FW)), which may be stored partially in a ROM (not shown) such that processing unit is operable selectively in: (1) a data programming or write mode, where the processing unit activates the input/output interface circuit to receive data from the host computing motherboard and/or the fingerprint reference data from fingerprint sensor under the control of the host computing motherboard, and store the data and/or the fingerprint reference data in the flash memory module; (2) a data retrieving or read mode, where the processing unit activates the input/output interface circuit to transmit data stored in the flash memory module to the host computing motherboard; or (3) a data resetting or erasing mode, where data in stale data blocks are erased or reset from the flash memory module. In operation, host computing motherboard sends write and read data transfer requests to the first flash memory device via the interface bus, then the input/output interface circuit to the processing unit, which in turn utilizes a flash memory controller (not shown or embedded in the processing unit) to read from or write to the associated at least one flash memory module. In one embodiment, for further security protection, the processing unit automatically initiates an operation of the data resetting mode upon detecting a predefined time period has elapsed since the last authorized access of the data stored in the flash memory module.

The optional power source is mounted on the card body, and is connected to the processing unit and other associated units on card body for supplying electrical power (to all card functions) thereto. The optional function key set, which is also mounted on the card body, is connected to the processing unit, and is operable so as to initiate operation of processing unit in a selected one of the programming, data retrieving and data resetting modes. The function key set may be operable to provide an input password to the processing unit. The processing unit compares the input password with the reference password stored in the flash memory module, and initiates authorized operation of the first flash memory device upon verifying that the input password corresponds with the reference password. The optional display unit is mounted on the card body, and is connected to and controlled by the processing unit for displaying data exchanged with the host computing motherboard.

A second electronic environment is shown in a second environment in FIG. 1B. The second environment is very similar to the first environment as shown in FIG. 1A. The differences are the optional components (i.e., display unit, power source and functional key set) are not included in card body of the second electronic flash memory device. Instead, such functionalities may be implemented using the existing ones provided by the host computing motherboard via the interface bus.

Shown in FIG. 1C, the third electronic flash memory device includes a card body with a processing unit, an I/O interface circuit and at least one flash memory module mounted thereon. Similar to the two aforementioned environments, the third flash memory device couples to a host computing motherboard via an interface bus. Fingerprint functions such as scanning and verification are handled by the host computing motherboard.

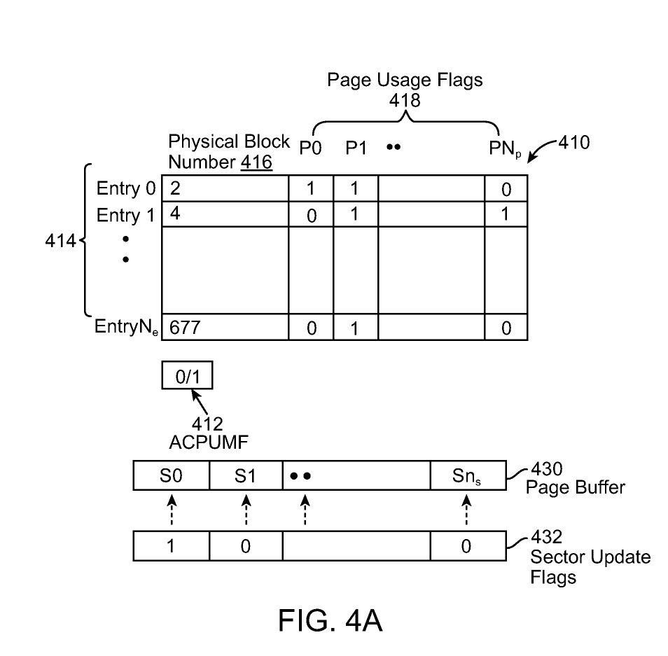

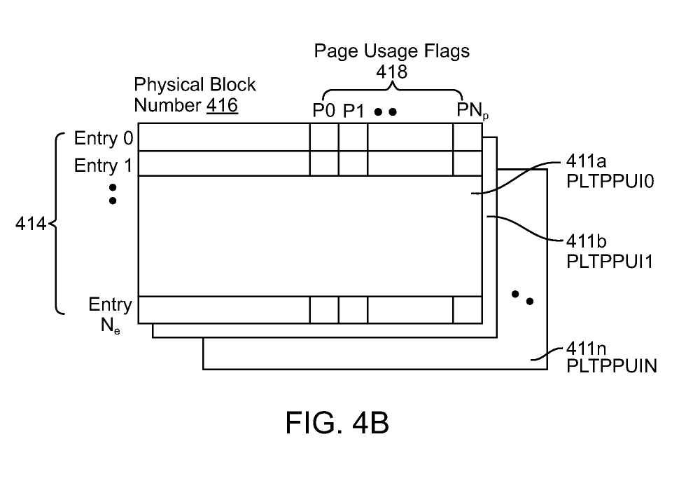

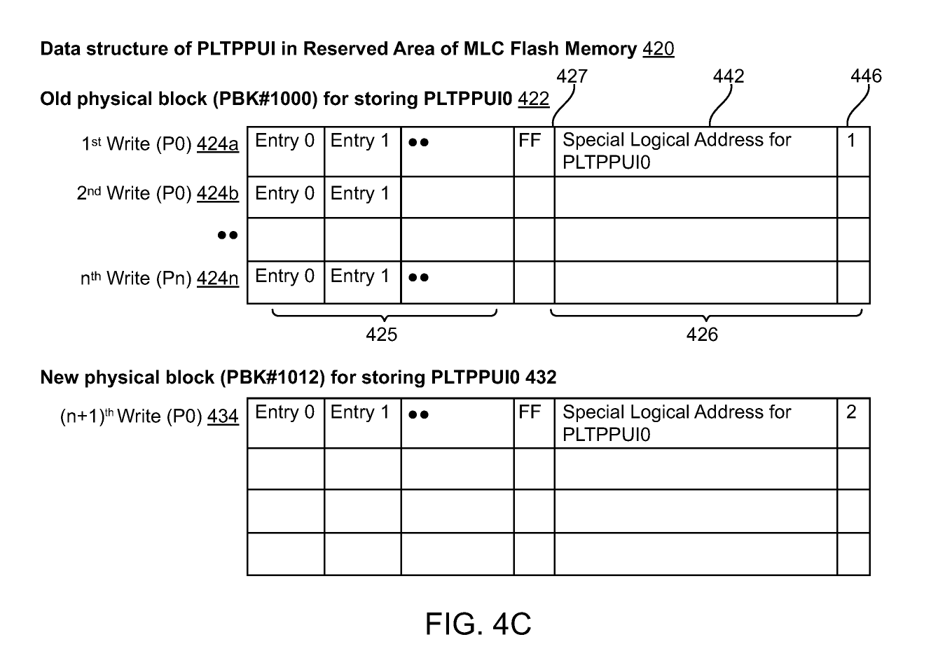

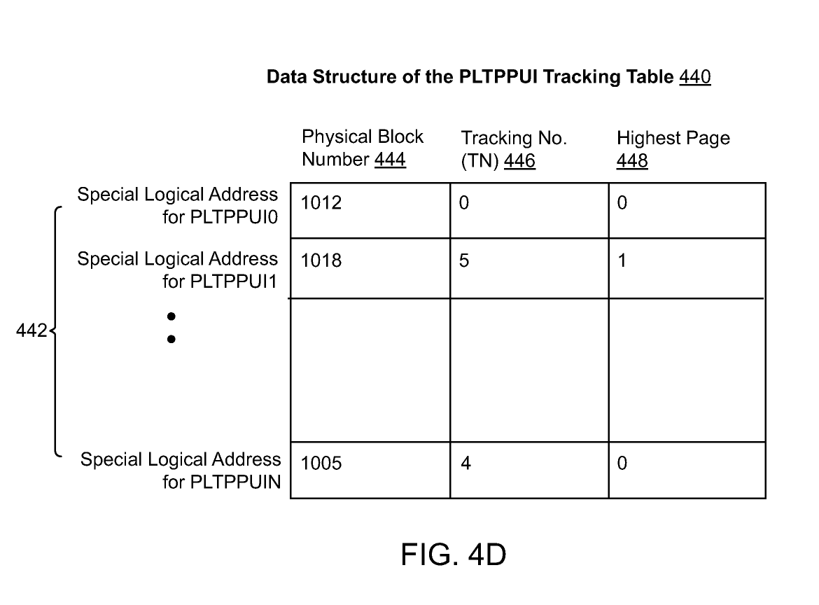

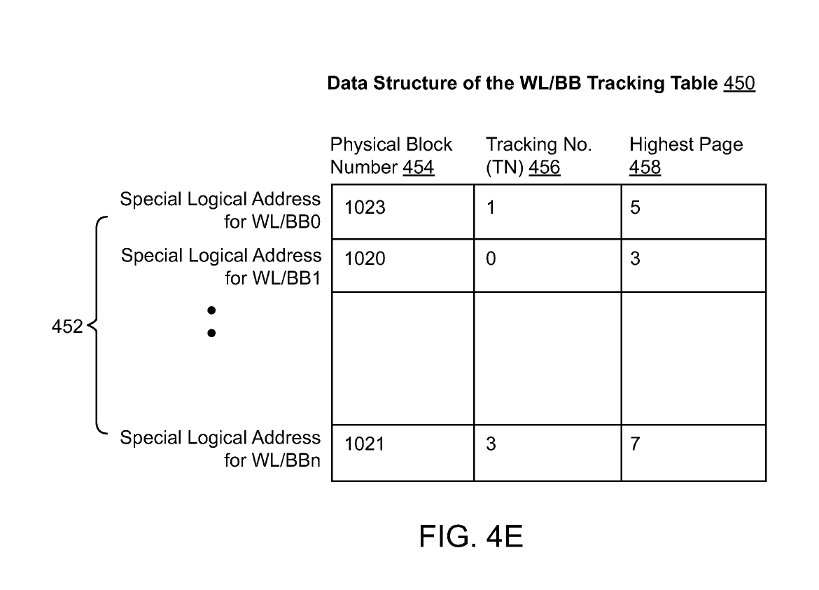

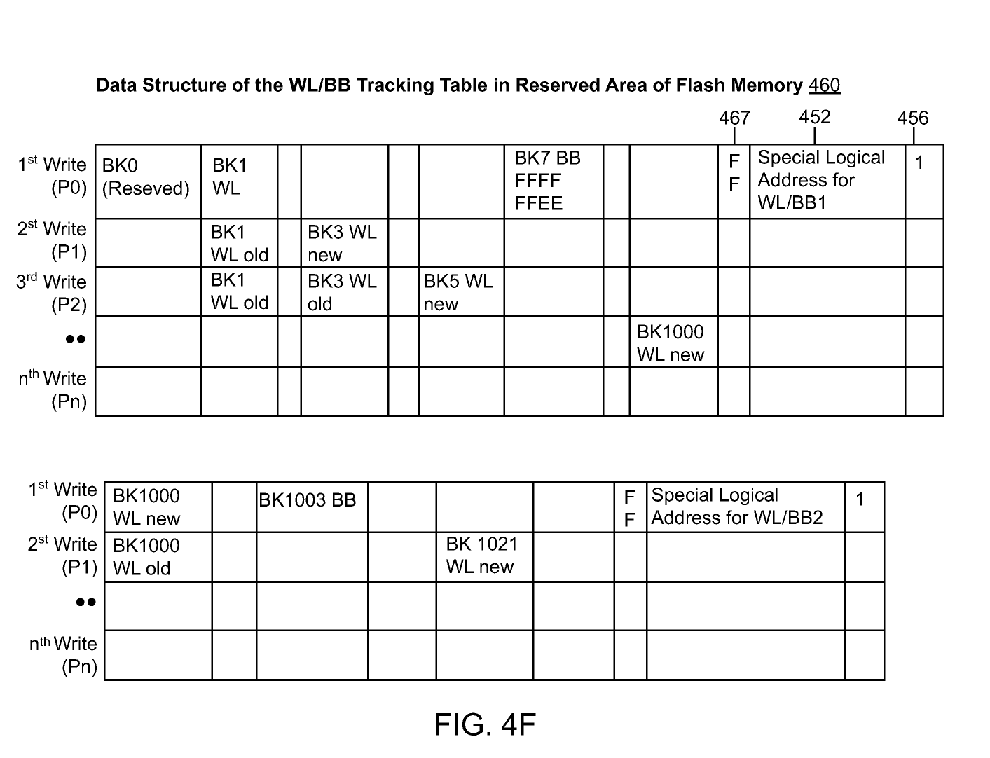

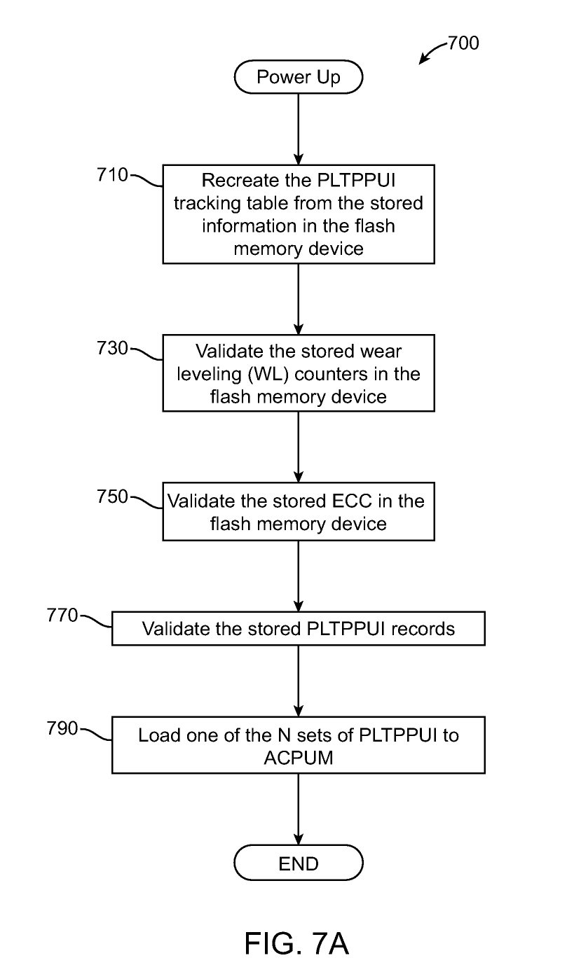

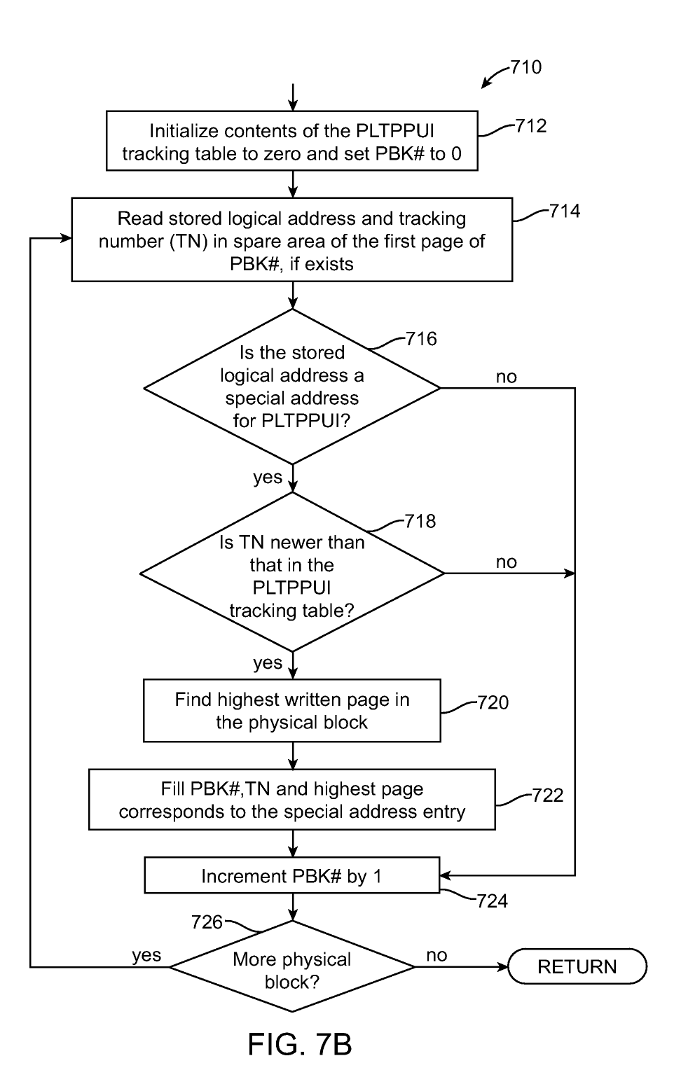

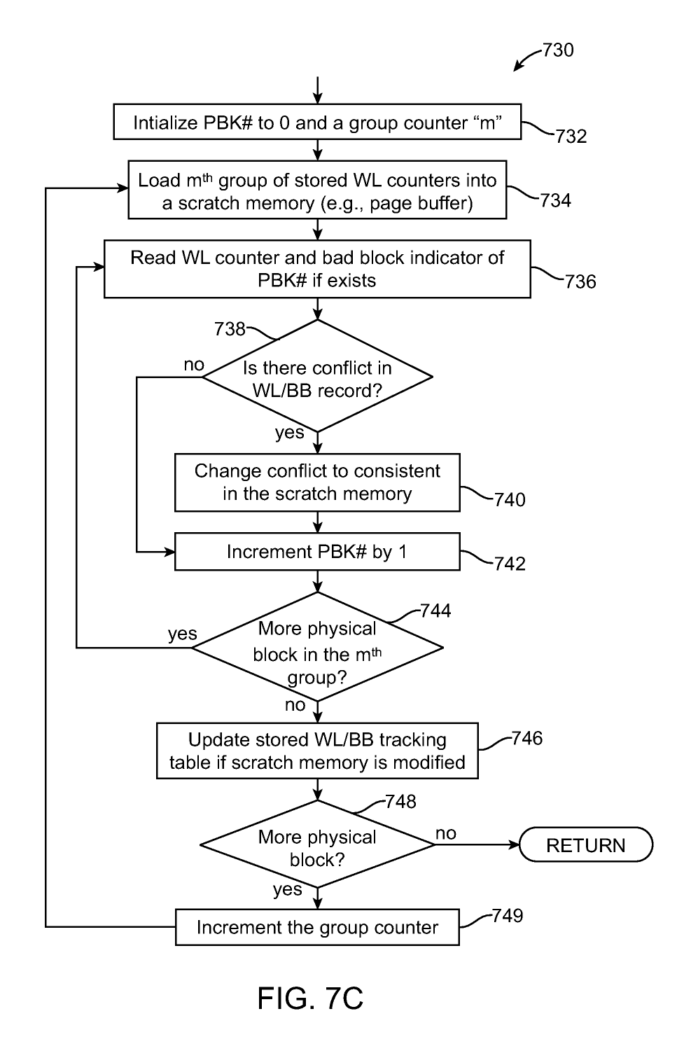

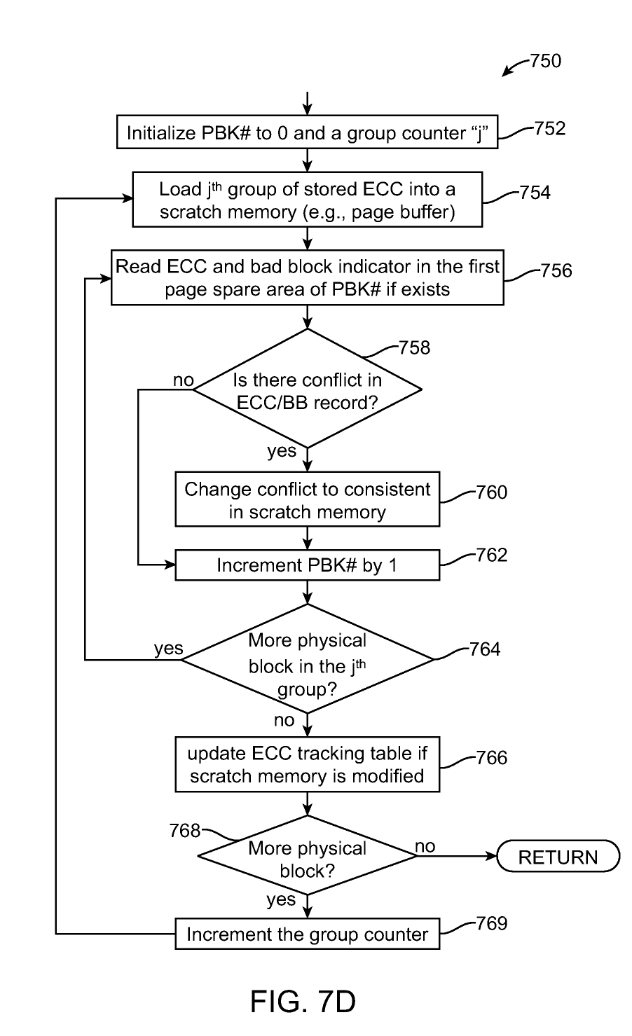

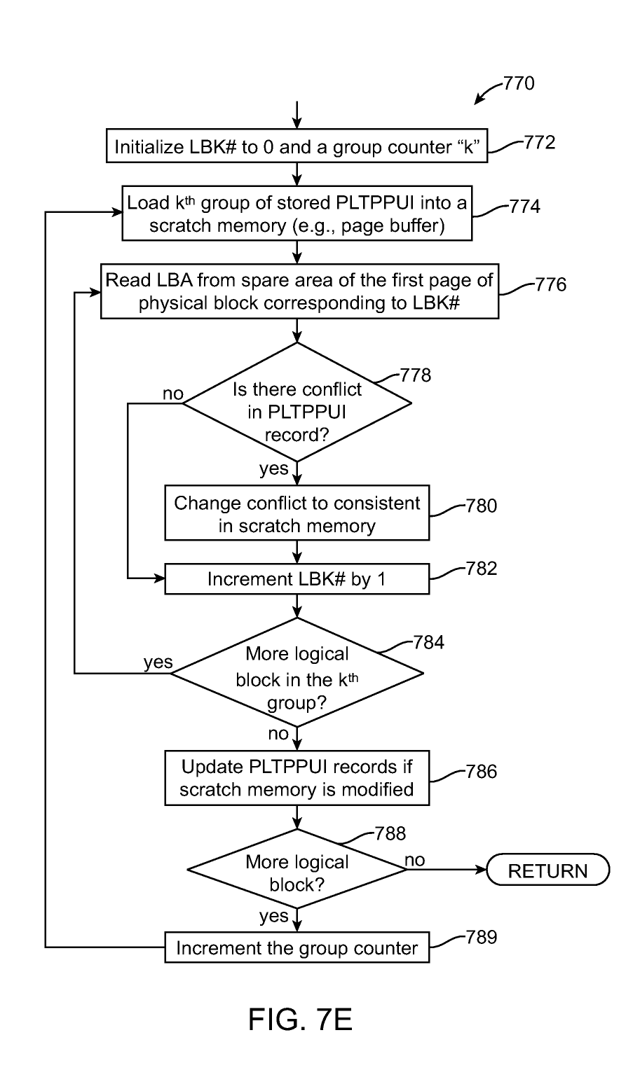

Referring now to FIG. 2A, which is a diagram depicting an exemplary data structure 200 of a flash memory module 201 (e.g., flash memory module 103 of FIG. 1C) in accordance with one embodiment of the present invention. The flash memory module 201 is divided into a plurality of physical blocks e.g., PBK#0, PBK#1, PBK#2, . . . ). In general, there are three categories of physical blocks: 1) the first block 202 (i.e., PBK#0); 2) normal usage data blocks 204 (i.e., PBK#1, PBK#2, . . . , PBK#n_{b}); and 3) reserved blocks 206 (i.e., PBK#n_{b+1}, . . . PBK#nₘₐₓ₋₁). The first block (PBK#0) 202 is guaranteed to be a good block and used by the manufacturer to store certain information such as Flash Timing Parameter (FTP), and other information by Initial Manufacturing Program (IMP), which cannot be alter by users. The manufacturer may define a percentage (e.g., 95%) of the total capacity as normal usage data blocks and the rest as reserved. The normal usage data blocks 204 are configured for user to store user data, although the first block (i.e., PBK#1) of the normal usage data blocks 204 is generally used for storing Master Boot Record (MBR), which contains critical data for operation of a computing device. Lastly, the reserved blocks 206 are configured to be accessed by a program module (e.g., FW) via special memory addresses in accordance with one embodiment of the present invention. Examples of the special memory address are 0xFFFF0000, 0xFFFF0001, 0xFFFFFF00, 0xFFFFFF01, etc. Each block is further divided into a plurality of pages 208 (e.g., P0, P1, . . . , Pnₚ). Each of the pages 208 includes a data area 210 and a spare area 212. The data area is partitioned into a plurality of sectors (e.g., S0, S1, . . . , Snₛ). In one embodiment, each sector stores 512-byte of data. The spare area 212 is configured to provide three different fields: 1) a block indicator (BB) 214, a logical address area 216 and an error correction code (ECC) area 218. When a block is tested no good by the manufacturer, the block indicator 214 of that block is set to a special code to indicate a bad block that cannot be used. The logical address area 216 is configured for identifying of that particular physical block for initialization of the flash memory device. More details are described in FIG. 4E and FIG. 4F for the reserved physical blocks as used by an embodiment of the present invention. Detailed processes of initialization are shown in FIGS. 7A-7E. The ECC area 218 is configured to store the ECC for ensuring data integrity.

In order to access the data stored in the normal usage blocks 204 of the flash memory module 201, the host computing motherboard 109 transmits a data transaction request (e.g., data read or write) along with a logical sector address (LSA) to the flash memory device (e.g., flash memory device 140 of FIG. 1C). The processing unit 102 of the flash memory device converts the received LSA into a physical address (i.e., specific block, page and sector numbers) before any data transaction can be performed. Traditionally, the conversion is performed by an address look up table with a one-to-one relationship to the physical address. This solution works for a flash memory device with relatively small capacity, because the address look up table is implemented with a static random access memory (SRAM). It would not be feasible in terms of cost and physical space to include SRAM that grows linearly as the capacity of the flash memory device especially for a large capacity MLC based flash memory device. For example, a large capacity (say 32 Giga-Byte (GB)) MLC based flash memory device using 2112-byte page (i.e., 2048-byte data plus 64-byte spare) and 128 pages per block, it would require more than 2 MB bytes of SRAM to hold the entire address look up table.

FIG. 2B is a diagram showing an exemplary scheme for partitioning a logical sector address in accordance with one embodiment of the present invention. A logical sector address (LSA) 250 is traditionally partitioned as three parts: block 252, page 254 and sector 256. The block portion 252 is also referred to as logical block address (LBA). According to one aspect of the present invention, the LSA 250 is partitioned into four parts: set 262, entry 264, page 254 and sector 256. The page 254 and sector 256 remain the same. And the block 252 is further partitioned into two parts: the set 262 and the entry 264. In other words, instead of just using block 252 as basic unit, the blocks are divided into a plurality of sets 262. Each of the sets 262 includes a plurality of entries 264. For example, if a 24-bit LSA 270 is partitioned in the following manner: 6-bit for set, 8-bit for entry, 8-bit for page and 3-bit for sector, the LSA 270 could represent up to 64 sets of 256 entries (i.e., 16,384 blocks) with each block containing 128 pages and each page containing 8 sectors of 512-byte of data. In this document, the number of the plurality of sets is N, where N is a positive integer.

To carry out the address partition scheme of the present invention, the manufacturer may predefine number of sets and entries in the first physical block (i.e., PBK#0) by the IMP. Instead of mapping all of the logical sector addresses (LSA) to a physical address in a memory, only a portion of the LSA (i.e., a set) is included such that only a limited size of memory is required for address correlation and page usage information. In other words, a limited size memory is configured to hold one set of entries with each entry including an address of the corresponding physical block and a plurality of corresponding page usage flags (see FIG. 4A for details). For example, 18-byte (i.e., 2-byte for the physical block address plus 128-bit or 16-byte for 128 page usage flags) is required for each entry, hence a total of 4608-byte of memory is required for a set with 256 entries.

However, in order to correlate a logical block address to a unique physical block, every entry in each of the plurality of sets must correlate to a unique physical address and a set of page usage flags. Since the limited size memory only has capacity of holding one set of such information, an embodiment of the present invention requires that information of all of the plurality of sets be stored in reserved area 206 of the flash memory 201. Only a relevant set of the plurality of sets is loaded into the limited size memory in response to a particular data transfer request from a host computing system 109. The relevant set is defined as the set with one of the entries matches the entry number derived from the LSA associated with the received data transfer request.

Since there are N sets of address correlation and page usage information stored in the flash memory, each of the N sets is referred to as a partial logical-to-physical address and page usage information (hereinafter ‘PLTPPUI’) appended with a set number (e.g., ‘PLTPPUI0’, ‘PLTPPUI1’, . . . ‘PLTPPUIN’).

In order to simplify the examples and drawings in the Specification, an example with small numbers is used for demonstrate the relationship between LSA, LBA, sector, page, entry and set numbers. Those of ordinary skill in the art will understand implementation of an embodiment of the present invention can be with larger numbers. The following example uses a flash memory with four sectors per page, four pages per block and four entries per set and a logical sector address 159 (i.e., LSA=159) is represented by a binary number “10 01 11 11”. As a result, the least significant four bits of LSA represent sector and page numbers with the two lowest bits for the sector number and the next two for the page number, as each two-bit represents four distinct choices—0, 1, 2 and 3. After truncating the four least significant bits of LSA, the remaining address becomes the corresponding logical block address (LBA). In this example, LBA has a binary value of ‘1001’. Because there are four entries per set in this example, two least significant bits of LBA represent the entry number (i.e., offset number in each set). The remaining high bits of LBA represent the set number. A summary of this example is listed in Table 1.

TABLE 1

| 10 | 01 | 11 | 11 |
|---|---|---|---|
| Set Number | Entry Number | Page Number | Sector Number |

According to one aspect of the present invention, an indexing scheme enables the processing unit 102 to translate logical sector addresses (LSAs) and/or logical block addresses (LBAs) provided, in conjunction with a data transfer request, by the host computing motherboard 109 to physical block numbers or addresses (PBK#) in the flash memory device 140. The indexing scheme comprises a plurality of sets of PLTPPUI and physical characteristics of the flash memory such as total number of sets, entries, pages and sectors. And ratios among the set, entry, page and sector. The processing unit 102 can utilize the indexing scheme to determine which sectors of the flash memory are available for each particular data transfer request.

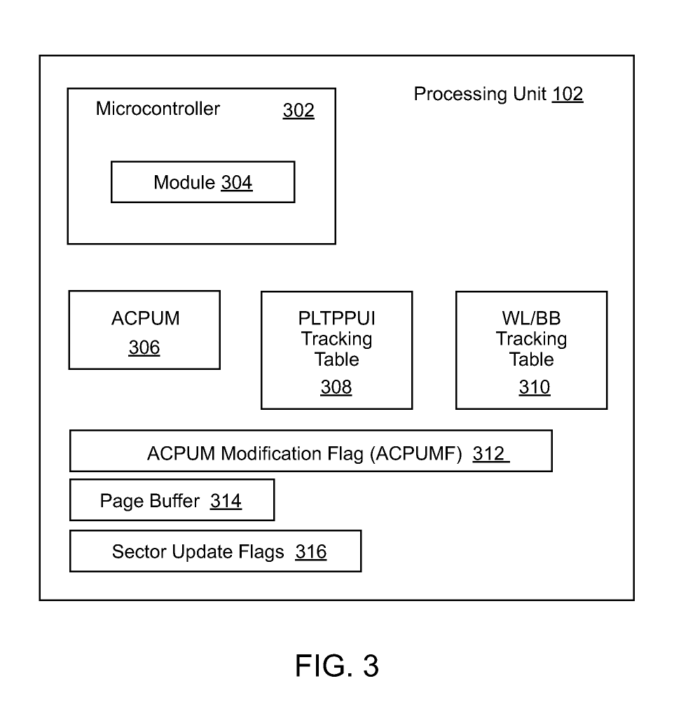

FIG. 3 is a simplified block diagram showing salient components of the process unit 102 of an electronic flash memory device (e.g., flash memory devices 102 of FIG. 1C) in accordance with one embodiment of the present invention. The processing unit 102 comprises a microcontroller or microprocessor 302, an address correlation and page usage memory (ACPUM) 306, a PLTPPUI tracking table 308, a wear leveling and bad block (WL/BB) tracking table 310, a ACPUM modification flag (ACPUMF) 312, a page buffer 314 and a set of sector update flags 316.

The microcontroller 302 with a flash memory controlling program module 304 (e.g., a firmware (FW)) installed thereon is configured to control the data transfer between the host computing motherboard 109 and the at least one flash memory module 103. The ACPUM 306 is configured to provide an address correlation table, which contains a plurality of entries, each represents a correlation between a partial logical block address (i.e., entries) to the corresponding physical block number. In addition, a set of page usage flags associated with the physical block is also included in each entry. The ACPUM 306 represents only one of the N sets of PLTPPUI, which is stored in the reserved area of the flash memory. In order to keep tracking the physical location (i.e., physical block number) of each of the N sets of PLTPPUI, the physical location is stored in the PLTPPUI tracking table 308. Each item is the PLTPPUI tracking table 308 corresponds a first special logical address to one of the N sets of PLTPPUI. The wear leveling counters and bad block indicator for each physical block is stored in a number of physical blocks referred by corresponding second special logical addresses (e.g., ‘0xFFFFFF00’). The WL/BB tracking table 310 is configured to store physical block numbers that are assigned or allocated for storing these physical block wear leveling counters and bad blocks. The ACPUM modification flag (ACPUMF) 312 is configured to hold an indicator bit that tracks whether the ACPUM 306 has been modified or not. The page buffer 314 is configured to hold data in a data transfer request. The page buffer 314 has a size equaling to the page size of the flash memory 201. The sector update flags 316 are configured to hold valid data flag for each of the corresponding sectors written into data area of the page buffer 314. For example, four sector update flags are be required for a page buffer comprising four sectors. The page buffer 314 also includes a spare area for holding other vital information such as error correction code (ECC) for ensuring data integrity of the flash memory.

FIGS. 4A-4F collectively show exemplary data structures used for managing memory addresses of the flash memory of FIG. 2A in accordance with one embodiment of the present invention. The ACPUM data structure 410 contains Nₑ rows of entries 414, where Nₑ is a positive integer. Each row contains a physical block number or address (PBK#) 416 and a plurality of page usage flags 418 associated with the PBK#. The number of pages (Nₚ) is determined by the physical flash memory cell structure and defined by the IMP. ACPUMF 412 contains one bit, which is a toggle switch representing whether the ACPUM 306 has been modified or not. The ACPUMF 412 may be implemented as a register containing either 0 (not modified) or 1 (modified). The page buffer 430 includes a data area containing plurality of sectors (S1, S2, . . . , Snₛ) and a spare area (not shown in FIG. 4A) containing other information such as ECC. A set of sector update flags 432 is configured to represent respective sectors in the page buffer 430. Each of the sector update flags 432 indicates either a corresponding sector contains a valid data or not. In one implementation, valid data is represented as “1”, while initial or stale state as “0”. These flags may be implemented in a different logic such as reversing the binary representation. As discussed in the prior sections and shown in FIG. 4B, there are N sets of PLTPPUI 411a-n, where N is a positive integer. The N sets of PLTPPUI 411a-n represent all of the logical blocks in correlation with physical blocks. Only one of the N sets is loaded into the ACPUM 306 at one time.

Each set of the PLTPPUI is stored in the reserved area 206 of the flash memory 201 of FIG. 2A in a data structure 420 shown in FIG. 4C. The contents of each set of PLTPPUI are stored in one page of a physical block. For example, the PLTPPUI0 is stored at one of a plurality of first special logical addresses “0xFFFF0000”, which corresponds to the first page (P0) 424a of a physical block ‘PBK#1000’ 422 initially. Due to the MLC flash memory data programming rules, each page can only be programmed or written once (i.e., NOP=1) and data programming within one block can only be in a ascending page order. The second data programming or write can only be into the second page (P1) 424b until the n^{th} write to the last page (Pn) 424n of the block ‘PBK#1000’ 422. After that, the next data programming, the (n+1)^{th} write, must be written to the first page (P0) 434 of a new physical block (PBK#1012) 432 just assigned or allocated according to the WL rules. In storing ACPUM 306 into the flash memory, each entry of the ACPUM 306 is written sequentially in the data area 425 of the page. When a first page of a new block is programmed, after the data area has been written, other vital information is written into the spare area 426. The other information include at least the following: a bad block indicator 427, the special logical address 428 issued by the FW for each of the N sets of PLTPPUI and a tracking number 429 for each special logical address. The bad block indicator 427 showing ‘FF’ means a good block. The first special logical address 442 may be ‘0xFFFF0000’. And the tracking number (TN) 446 is set to zero for an initial physical block corresponding to each of the first special logical addresses. The tracking number 446 is incremented by one as a new block is assigned or allocated for storing a particular set of PLTPPUI.

FIG. 4D is a diagram illustrating an exemplary data structure 440 of the PLTPPUI tracking table 308 of FIG. 3. The PLTPPUI tracking table 308 contains a plurality of rows representing a plurality of first special logical addresses 442, one for each of the N sets of PLTPPUI. Each of the N rows contains a physical block number 444, a tracking number (TN) 446 and highest page number 448. The first row of the PLTPPUI tracking table 308 corresponds to the example shown in FIG. 4C.

Similar to the data structure of the PLTPPUI tracking table, an exemplary data structure 450 of a WL/BB tracking table 310 is shown in FIG. 4E. Instead of first special logical addresses for each of the N sets of PLTPPUI, each row is for a second special address 452 of a block of the WL/BB tracking table 310. In one implementation, the second special address 452 may be ‘0xFFFFFFF0’. An exemplary data structure 460 for storing the WL/BB tracking table in the reserved area of a flash memory is shown in FIG. 4F. Similarly, the MLC flash memory data programming rules dictate the data to be written to a new page for each update. The spare area stores the block indicator 467, the second special logical address 452 and tracking number 456.

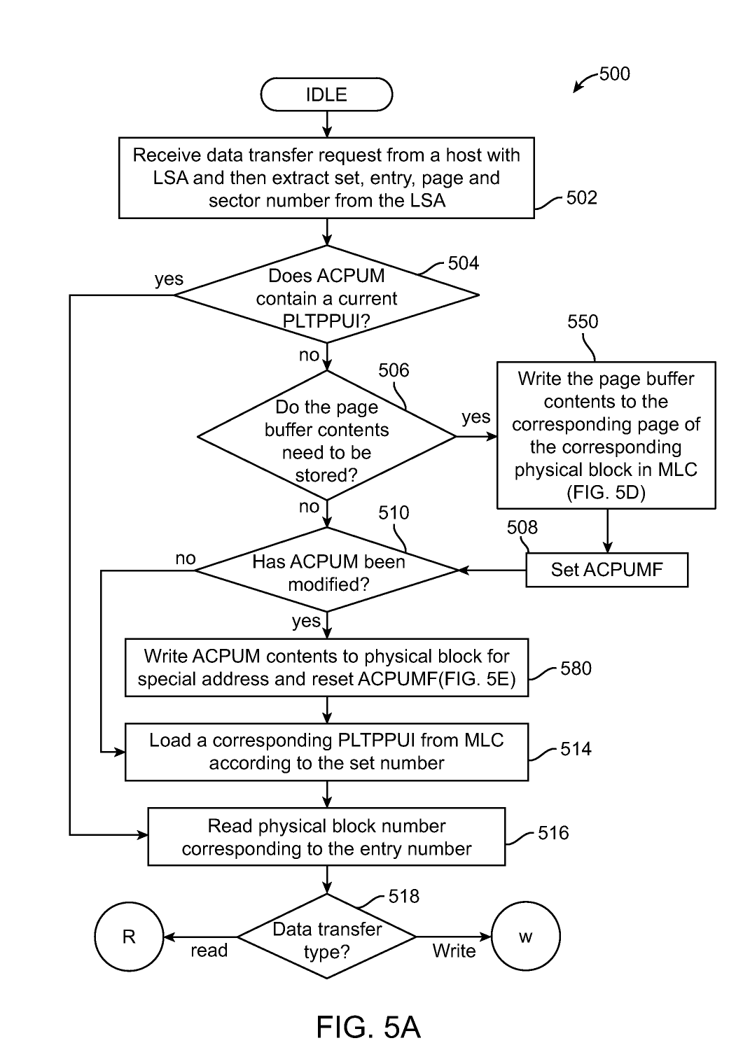

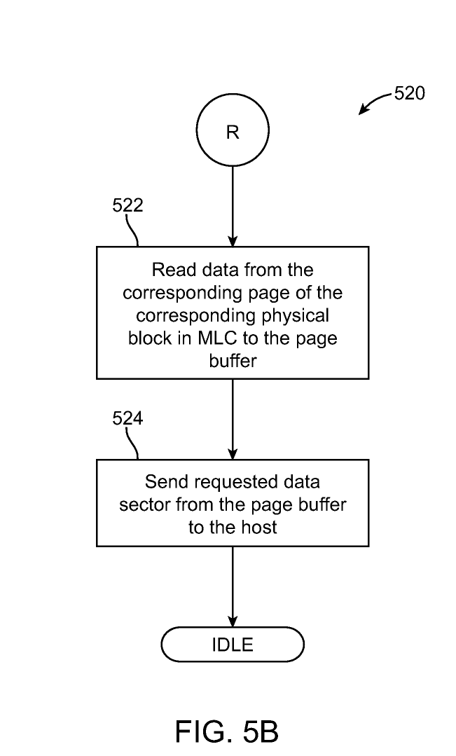

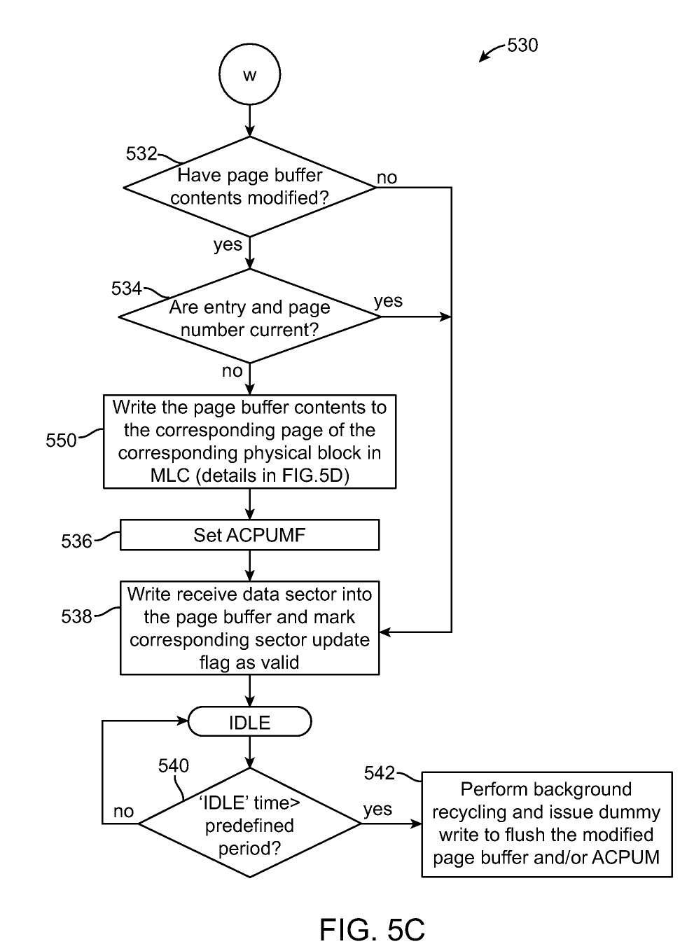

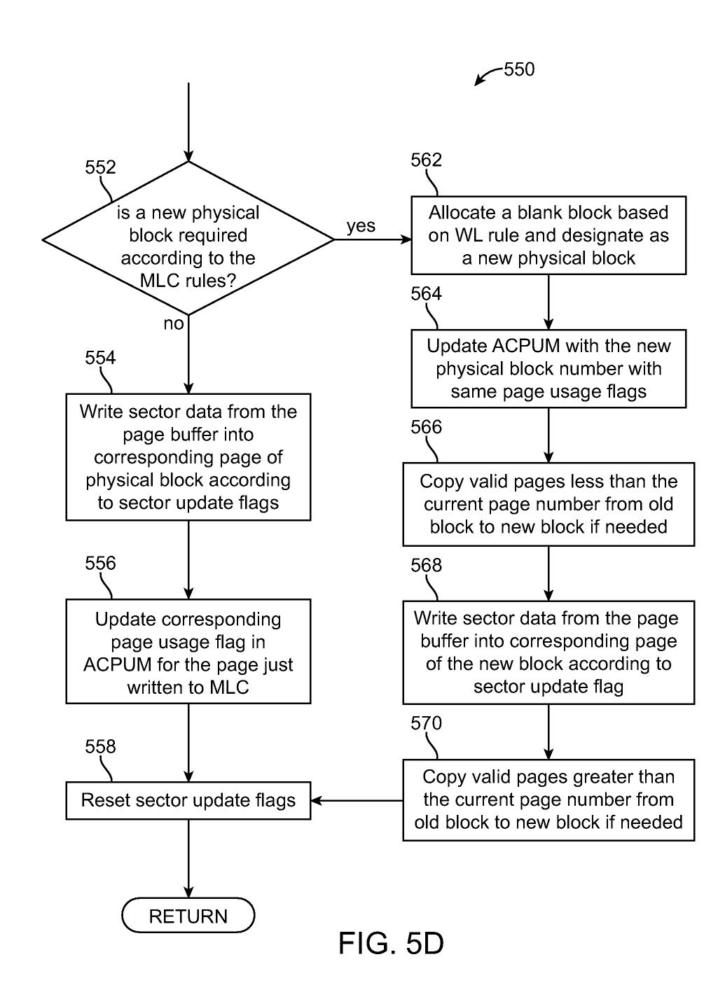

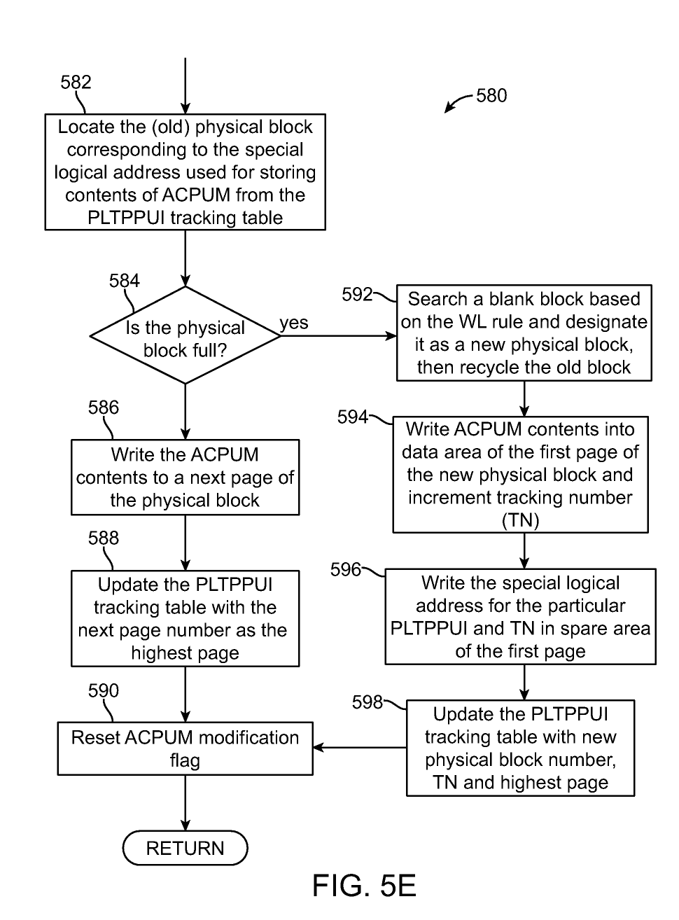

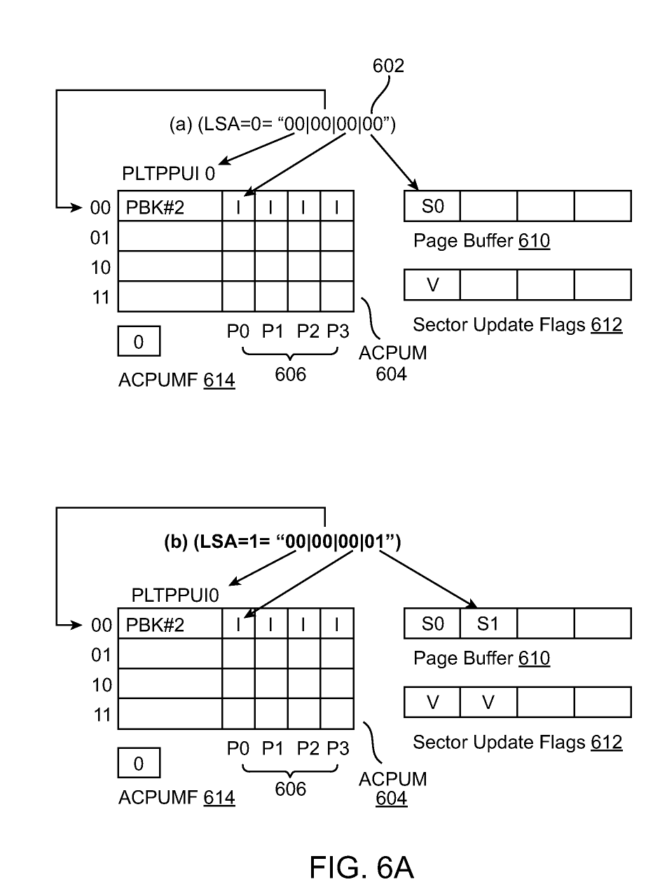

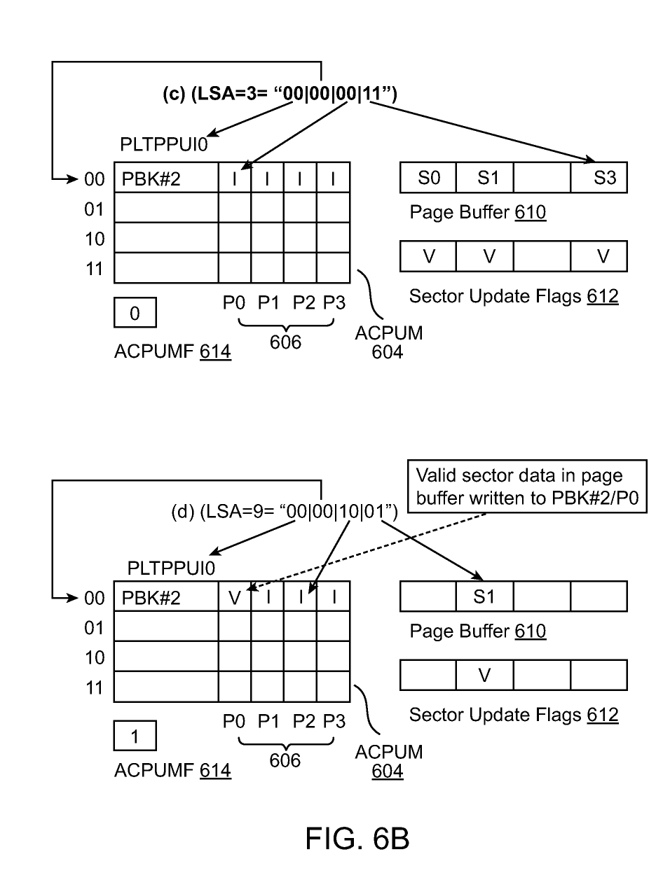

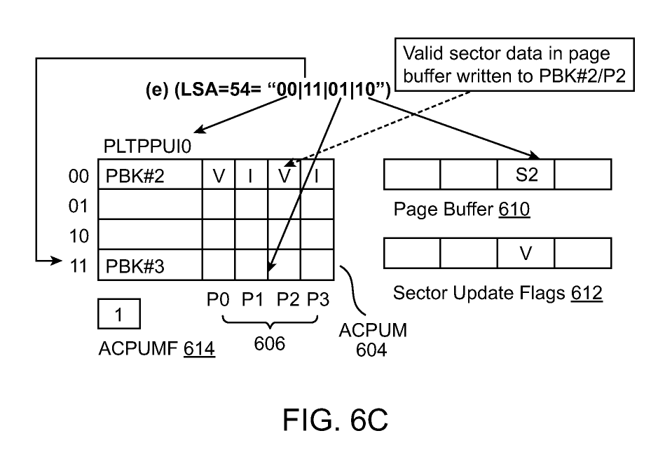

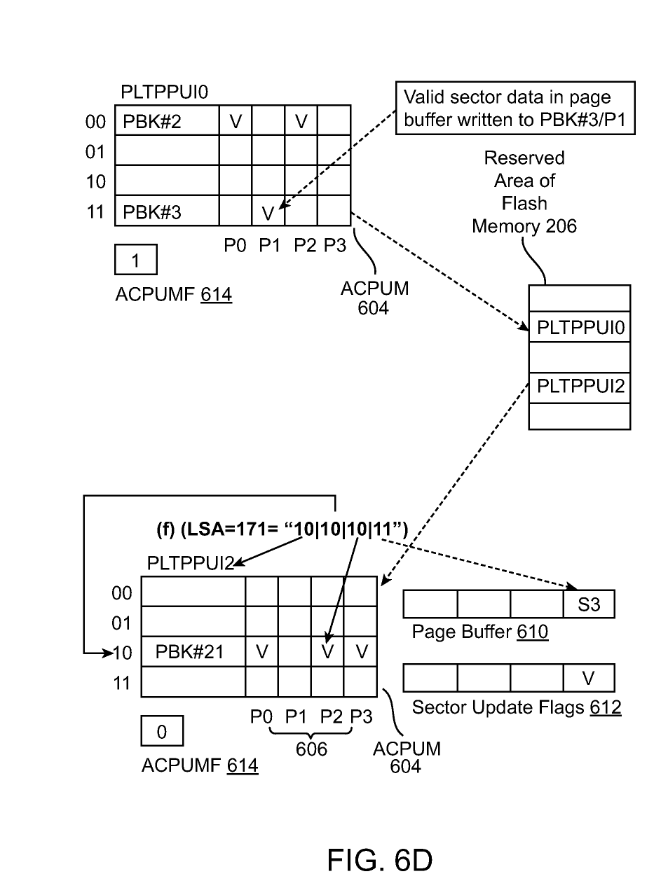

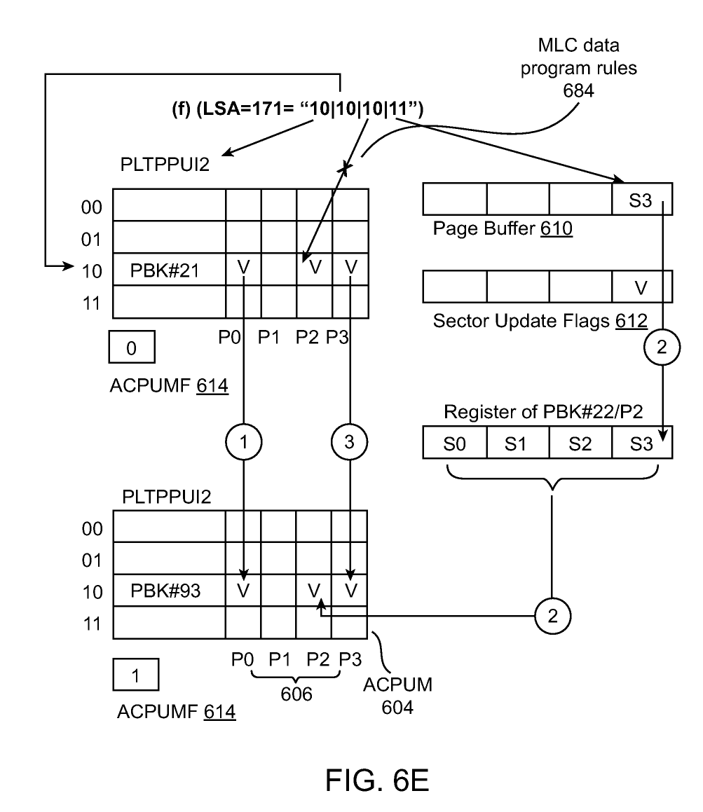

Referring now to FIGS. 5A-5E, which collectively show a flowchart illustrating an exemplary process 500 of conducting data transfer requests of the flash memory of FIG. 2A in accordance with one embodiment of the present invention. The process 500 is preferably understood in conjunction with previous figures and examples shown in FIGS. 6A-6D. The process 500 is performed by the microcontroller 302 with a flash memory controller program module 304 installed thereon.

The process 500 starts in an ‘IDLE’ state until the microcontroller 302 receives a data transfer request from a host (e.g., the host computing board 109 of FIG. 1C) at 502. Also received in the data transfer request is a logical sector address (LSA), which indicates the location the host wishes to either read or write a sector of data (i.e., 512-byte sector). Based on the parameters defined by the IMP and the physical characteristics of the MLC based flash memory, the received LSA is processed to extract the set, entry, page and sector numbers (see Table 1 for an example) included therein. After the received LSA has been processed, the process 500 moves to decision 504. It is determined whether the ACPUM 306 has been loaded with a set of PLTPPUI that covers the received LSA. If ‘yes’, the process 500 reads out the physical block number (PBK#) corresponding to the entry number of the received LSA at 516 before moving to another decision 518, in which it is determined whether the data transfer request is read or write (i.e., program).

If the decision 504 is ‘no’, the process 500 moves to decision 506. The process 500 checks whether the contents of the page buffer 430 need to be stored. In one implementation, the process 500 checks the sector update flags 432 that correspond to sectors in the page buffer 430. If any one of the flags 432 has been set to ‘valid’, then the contents of the page buffer 430 must be stored to the corresponding page of the corresponding physical block of the MLC flash memory at 550 (i.e., the decision 506 is ‘yes’). Detailed process of step 550 is shown and described in FIG. 5D. After the contents of the page buffer 430 have been stored, the process 500 sets the ACPUM modification flag (ACPUMF) 412 to a ‘modified’ status at 508. In other words, the ACPUM 306 has been modified and needs to be stored in the flash memory in the future. Then the process 500 moves to yet another decision 510.

Otherwise if ‘no’ at decision 506, the process 500 moves the decision 510 directly. It is then determined if the ACPUM 306 has been modified. If ‘yes’, the process 500 moves to 580, in which, the process 500 writes the contents of the ACPUM 306 to one of a plurality of first special logical addresses (e.g., ‘0xFFFF0000’ for PLTPPUI0, or ‘0xFFFF0001’ for PLTPPUI1, etc.) for storing corresponding set of PLTPPUI in the reserved area of the flash memory. The ACPUM modification flag 412 is reset at the end of 580. Detailed process of step 580 is shown and described in FIG. 5E. Then, at 514, the process 500 loads a corresponding set of PLTPPUI to the ACPUM 306 from the flash memory based on the set number extracted from the received LSA. Once the ACPUM 306 has been loaded, the process 500 reads the physical block number that corresponds to the entry number at 516 before moving to decision 518. If ‘no’ at decision 510, the process 500 skips step 580 and goes directly to 514.

Next, at decision 518, if the data transfer request is a data read request, the process 500 continues with a sub-process 520 shown in FIG. 5B. The process 500 or sub-process 520 reads data from the corresponding page of the physical block in the flash memory to the page buffer 430. The corresponding page number is derived from the received LSA, and the physical block number is obtained through the ACPUM 306 for the entry numbers at 516. Finally, the process 500 sends the requested data sector from the page buffer 430 to the host 109 before going back the ‘IDLE’ status waiting for another data transfer request.

If the data transfer request is a data write or program request, the process 500 continues with a sub-process 530 shown in FIG. 5C. The process 500 or sub-process 530 moves to decision 532, in which it is determined whether the contents of the page buffer 430 have been modified. If ‘no’, the process 500 writes received data sector into the page buffer 430 according to the sector number derived from the received LSA, and marks the corresponding sector of the sector update flags 432 to indicate valid data in that particular sector has been written in the page buffer 430 at 538. The process 500 then moves back to the ‘IDLE’ state waiting for another data transfer request.

If ‘yes’ at decision 532, the process 500 moves to decision 534. It is determined if the received data sector is in the same entry and page numbers. If ‘yes’, the process 500 writes the received data sector to the page buffer 430 at 538 before going to the ‘IDLE’. If ‘no’ at decision 534, the process 500 writes the page buffer contents to the corresponding page of the physical block of the flash memory at 550. Next, the process 500 sets the ACPUM modification flag 412 to a ‘modified’ status at 536. Next, at 538, the process 500 writes the received data sector to the page buffer before going back to the ‘IDLE’ state.

Finally, in additional to managing data read and write requests, the process 500 regularly performs a background physical block recycling process so that the blocks containing only stale data can be reused later. When the process 500 is in the ‘IDLE’ state, it performs test 540, in which it is determined if the idle time has exceeded a predefine time period. If ‘yes’, the process 500 performs the background recycling process, which may include issuing a dummy data write request to force the page buffer 430 and/or modified ACPUM 306 to be written to corresponding locations of the flash memory at 542. In one embodiment, the dummy data write/program command may be issued to rewrite some of seldom touched physical blocks, for example, physical blocks used for storing user application or system program modules.

Referring to FIG. 5D, a detailed process of step 550 is shown. First, the process 500 is at decision 552, in which it is determined if a new blank physical block is required for storing the contents of the page buffer 430 based on the MLC based flash memory data programming rules. The rules are as follows: 1) each page can only be programmed once (conventionally referred to as ‘NOP=1’); and 2) data programming is performed to a page of a same block in the ascending or sequential order, or each new page must have a high page number in the same block. If ‘no’ at decision 552, the process 500 writes valid data sectors based on the sector update flags 432 from the page buffer 430 to the page register of the corresponding page of the corresponding physical block of the flash memory at 554. Next, at 556, the process 500 updates the corresponding one of the page usage flags in the ACPUM 306 for the page just written to the flash memory. The process 500 then resets the sector update flags at 558 before returning.

If ‘yes’ at decision 552, the process 500 searches for a blank physical block based on the wear leveling (WL) rule; once found, the process 500 designates it as a new block at 562. Then, the process 500 updates the ACPUM 306 with the new physical block number for the entry number and keeps the page usage flags the same. It is noted that the entry number is derived from the received LSA. Next, at 566, the process 500 copies all valid pages with page number less than the current page number from the old to the new physical block if needed. The current page number if the page number derived from the received LSA. Then, the process 500 writes the valid data sectors based on the sector update flags 432 from the page buffer 430 to the page register of the corresponding page of the new physical block at 568. Finally if necessary, the process 500 copies all valid pages with page number greater than the current page number from the old to the new physical block at 570. The process 500 resets the sector update flags at 558 before returning.

FIG. 5E is a flowchart illustrating step 580 of the process 500. First, in step 580, the process 500 locates the corresponding physical block in the reserved area of the flash memory using a particular one of the first special logical addresses from the PLTPPUI tracking table 308. The corresponding physical block is configured to store the contents of the current ACPUM 306, which is associated with the first special logical address, for example, ‘0xFFFF0000’ for ‘PLTPPUI0’, ‘0xFFFF0001’ for ‘PLTPPUI1’, etc. Next, at decision 584, it is determined whether the physical block is full or not. If ‘no’, the process 500 writes the contents of the ACPUM 306 to the next page in the physical block at 586. It is noted that the MLC based flash memory data programming rule dictates that only a new higher page in the same block is allowed to be programmed or written. Then the process 500 updates the PLTPPUI tracking table 308 to reflect that a new page has been written into the physical block by incrementing the highest page count 448 at 588. Finally, before returning at 590, the process 500 resets the ACPUM modification flag 412 to a ‘not modified’ status as the contents of the ACPUM 306 have been stored to the flash memory.

Referring back to decision 584, if ‘yes’, the process 500 searches a blank physical block as a new physical block (e.g., new physical block (PBK#1012) in FIG. 4C) in the reserved area of the flash memory based on the WL rule, and the old physical block (e.g. old physical block (PBK#1000) in FIG. 4C) is sent to a recycling queue for reuse at 592. Next, at 594, the process 500 writes the contents of the ACPUM 306 to the first page (e.g., ‘P0’ of FIG. 4C) of the new block. After the contents of the ACPUM have been stored in to the data area of the first page, the tracking number (TN) is incremented by one. Next, at 596, the first special logical address for this particular set of PTLPPUI and the new tracking number (TN) are written into the spare area of the first page. The process 500 then updates the PLTPPUI tracking table 308 with the new physical block number, the tracking number and the highest page number for the current set of PLTPPUI at 598. Before returning, the process 500 resets the ACPUM modification flag 412 to a ‘not modified’ status at 590.

FIGS. 6A-6D collectively show a sequence of data write or program requests to demonstrate the exemplary process 500 of FIGS. 5A-5E. In order to simplify the drawings and description, the sequence of the data write requests is perform on an exemplary flash memory with four sectors per page, four pages per block, and four entries per set. As a result of the simplified assumption, the logical sector address (LSA) 602 received along with the data write request can be processed in a scheme corresponding to Table 1. In other words, two least significant bits of the LSA represent the sector number, next two the page number, next two the entry number, and the remaining bits the set number.

The sequence of the data write requests starts with (a) writing to LSA=0, which corresponds to set 0 (i.e., PLTPPUI0), entry 0, page 0 and sector 0. PLTPPUI0 is loaded into ACUPUM 604, in which the first entry (i.e., entry 0) corresponds to physical block ‘PBK#2’ and page usage flags 606 are not set. The ACPUMF 614 is set to a ‘unmodified’ status. The sector data (S0) is written to the first sector of the page buffer 610 and the corresponding flag in the sector update flags 612 is set to a ‘V’ for valid data. The corresponding path in the process 500 for writing LSA=0 is as follows:
(1) receiving an LSA=0 and extracting set, entry, page and set numbers at 502;
(2) determining whether ACPUM contains a current set of PLTPPUI at 504 (yes, PLTPPUI0);
(3) reading physical block number (PBK#2) at entry 0 at 516;
(4) determining data transfer request type at 518 (write);
(5) determining whether page buffer contents have been modified at 532 (no);
(6) writing received data sector (S0) into the page buffer and marking corresponding sector (1^{st}) update flag at 538; and
(7) going back to ‘IDLE’ for next data transfer request.

The next data write request (b) is to write to LSA=1. The corresponding path is the process 500 is as follows:
(1) receiving an LSA=1 and extracting set, entry, page and set numbers at 502;
(2) determining whether ACPUM contains a current set of PLTPPUI at 504 (yes, PLTPPUI0);
(3) reading physical block number (PBK#2) at entry 0 at 516;
(4) determining data transfer request type at 518 (write);
(5) determining whether page buffer contents have been modified at 532 (yes);
(6) determining whether page and block number current at 534 (yes);
(7) writing received data sector (S1) into page buffer and marking corresponding sector (2^{nd}) update flag at 538; and
(8) going back to ‘IDLE’ for next data transfer request.

The next data write request (c) is to write to LSA=3 (FIG. 6B). The corresponding path is the process 500 is as follows:
(1) receiving an LSA=3 and extracting set, entry, page and set numbers at 502;
(2) determining whether ACPUM contains a current set of PLTPPUI at 504 (yes, PLTPPUI0);
(3) reading physical block number (PBK#2) at entry 0 at 516;
(4) determining data transfer request type at 518 (write);
(5) determining whether page buffer contents have been modified at 532 (yes);
(6) determining whether page and block number current at 534 (yes);
(7) writing received data sector (S3) into the page buffer and marking corresponding sector (4h) update flag at 538; and
(8) going back to ‘IDLE’ for next data transfer request.

The next data write request (d) is to write to LSA=9 (FIG. 6B). The corresponding path is the process 500 is as follows:
(1) receiving an LSA=9 and extracting set, entry, page and set numbers at 502;
(2) determining whether ACPUM contains a current set of PLTPPUI at 504 (yes, PLTPPUI0);
(3) reading physical block number (PBK#2) at entry 0 at 516;
(4) determining data transfer request type at 518 (write);
(5) determining whether page buffer contents have been modified at 532 (yes);
(6) determining whether page and block number current at 534 (no, same block but different page);
(7) writing the page buffer contents to the corresponding page (first page of PBK#2) at 550, which includes determining a new block is required at 552 (no); writing sector data to the first page of PBK#2 at 554; updating at the corresponding page usage flag (P0) in ACPUM at 556 and resetting sector update flags at 558;
(8) setting the ACPUMF (i.e., 1 for ‘modified’) at 536; and
(9) writing received data sector (S1) into the page buffer and marking corresponding sector (2^{nd}) update flag at 538 before going back to “IDLE”.

The next data write request (e) is to write to LSA=54 (FIG. 6C). The corresponding path is the process 500 is as follows:
(1) receiving an LSA=54 and extracting set, entry, page and set numbers at 502;
(2) determining whether ACPUM contains a current set of PLTPPUI at 504 (yes, PLTPPUI0);
(3) reading physical block number (PBK#3) at entry 3 (i.e., binary ‘11’) at 516;
(4) determining data transfer request type at 518 (write);
(5) determining whether page buffer contents have been modified at 532 (yes);
(6) determining whether page and block number current at 534 (no, different block);
(7) writing the page buffer contents to the corresponding page (third page of PBK#2) at 550, which includes determining a new block is required at 552; writing sector data to the third page of PBK#2 at 554 (no); updating at the corresponding page usage flag (P2) in ACPUM at 556 and resetting sector update flags at 558;
(8) setting the ACPUMF (i.e., 1 for ‘modified’) at 536; and
(9) writing received data sector (S2) into the page buffer and marking corresponding sector (3^{rd}) update flag at 538 before going back to “IDLE”.

Finally, the next data write request (f) is to write to LSA=171 (FIG. 6D). The corresponding path is the process 500 is as follows:
(1) receiving an LSA=171 and extracting set, entry, page and set numbers at 502;
(2) determining whether ACPUM contains a current set of PLTPPUI at 504 (no, PLTPPUI0 does not match PLTPPUI2);
(3) determining whether the page buffer contents need to be stored at 506 (yes);
(4) writing the page buffer contents to the corresponding page (second page of PBK#3) at 550, which includes determining a new block is required at 552; writing sector data to the second page of PBK#3 at 554; updating at the corresponding page usage flag (P1) in ACPUM at 556 and resetting sector update flags at 558 and setting the ACPUMF (i.e., 1 for ‘modified’) at 508; (shown in upper half of FIG. 6D)
(5) determining whether ACPUM has bee modified at 510 (yes);
(6) writing the ACPUM contents to corresponding physical block corresponding to the first special logical address for particular one of the N sets of PLTPPUI (PLTPPUI0), which includes locating the physical block from the PLTPPUI tracking table at 582; determining if the physical block is full at 584 (no); writing the ACPUM contents to a next page in the physical block at 586; updating the PTLPPUI tracking table with the next page number as the highest page number at 588; and resetting the ACPUMF at 590 (i.e., 0 for ‘unmodified’);
(7) loading a corresponding set of PLTPPUI (PLTPPUI2) from MLC to ACPUM at 514;
(8) reading physical block number (PBK#21) at entry 2 (i.e., binary ‘10’) at 516;
(9) determining data transfer request type at 518 (write);
(10) determining whether page buffer contents have been modified at 532 (no);
(11) writing received data sector into the page buffer ad marks the corresponding one of the sector update flags at 538 before going back to the ‘IDLE’ state;
(12) determining whether the ‘IDLE’ time has exceeded a predefined period at 540 (yes); and
(13) performing background recycling of old blocks with stale data and writing the modified page buffer and ACPUM to MLC at 542 (more details in FIG. 6E).

FIG. 6E is a diagram showing a complicated data program or write involving a physical block containing data that prevents another data program operation directly in accordance with the MLC data programming rules. Using the sequence of data write requests shown in FIGS. 6A-6D, after the final data write request (f) has been completed. Both the page buffer 610 and ACPUM 604 have been modified, but yet to be stored in the flash memory. Due to data already existed in certain pages of the physical block (i.e. PBK#21), the MLC data program rules 684 prevent the modified page buffer 610 be written to PBK#21. A new blank block (i.e., PBK#93) is allocated and assigned to hold the data in the old block (PBK#21) including updates from the modified page buffer 610. The corresponding path in the step 550 of the process 500 is as follows:
(1) determining a new physical block is required according to the MLC rules at 552 (yes);
(2) allocating and assigning a new block based on the wear leveling rule at 554;
(3) updating the ACPUM 604 with the new block number (PBK#93) and same page usage flags at 564;
(4) if required, copying the valid pages with page number smaller than the current page number (i.e., P2 or 3d page derived from LSA) from the old block (PBK#21) to the new block PBK#93) at 566 (see STEP 1 in circle in FIG. 6E);
(5) writing sector data (S3) from the page buffer to the register of the corresponding page of PBK#93 and thus updating the page in PBK#93 at 568 (see STEP 2 in circle in FIG. 6E);
(6) if required, copying the valid pages with page number greater than the current page number (i.e., P2 or 3d page derived from LSA) from the old block (PBK#21) to the new block PBK#93) at 570 (see STEP 3 in circle in FIG. 6E); and
(7) resetting the sector update flags at 558 before following the remaining data write steps of the process 500.

Referring now to FIGS. 7A-7E, which collectively are a flowchart illustrating an exemplary process 700 of initialization of a large capacity flash memory device in accordance with one embodiment of the present invention. The process 700 starts with a power up, for example, a flash memory device is plugged into a host 109. Next, the process 700 recreates the PLTPPUI tracking table 308 of FIG. 3 from stored N sets of PLTPPUI in the reserved area of the flash memory at 710. Then the process 700 validates the stored wear leveling and error correction code information with actual state of all of the physical blocks at steps 730 and 750, respectively. At 770, the process 700 verifies and validates the store PLTPPUI records against actual state of the physical blocks associated with a plurality of first special logical addresses. Finally, the process loads one of the N sets of PLTPPUI into ACPUM 306 at 790 before the initialization ends. The details of steps 710, 730, 750 and 770 are shown and described in respective FIGS. 7B, 7C, 7D and 7E.

Shown in FIG. 7B, the process 700 initializes contents of the PLTPPUI tracking table 308 to zero and a physical block counter (PBK#) to 0 at 712. Next, the process 700 reads stored logical address and tracking number (TN) in the spare area of the first page of the physical block ‘PBK#’ at 714. Then the process 700 moves to decision 716, in which it is determined whether the stored logical address is one of the first special addresses for storing PLTPPUI issued by the FW and microcontroller. If ‘no’, the process 700 simply skips this physical block by incrementing the physical block counter ‘PBK#’ by one at 724. Next if additional physical block determined at decision 726, the process 700 moves back to step 714 for processing the next physical block, otherwise the step 710 is done.

If ‘yes’ at the decision 716, the process 700 follows the ‘yes’ branch to another decision 718. It is then determined whether the stored tracking number is newer than the one listed in the PLTPPUI tracking table 308. For example, the contents in the PLTPPUI tracking table is initialized to zero, any stored tracking number (TN) greater than zero indicates that the stored records are newer. If ‘no’ at decision 718, the process 700 skips this physical block similar to the ‘no’ branch of decision 716. However, if ‘yes’ at decision 718, the process 700 searches and locates a highest written page in this physical block ‘PBK#’ at 720. Next, at 722, the process 700 writes the ‘PBK#’, TN and highest page number in the PLTPPUI tracking table corresponding to the first special logical address. Finally, the process 700 increments the physical block count ‘PBK#’ by one at 724, then moves to decision 726 to determine either moving back to 714 for processing another physical block or ending the step 710.

Details of step 730 are shown in FIG. 7C. At 732, the process 700 initializes a physical block counter ‘PBK#’ and a group counter ‘m’ to zero. Next, the process 700 loads a ‘m^{th}’ group of stored WL/BB tracking table into a scratch memory space (e.g., the page buffer 314 of FIG. 3) at 734. Then the process 700 reads the wear leveling (WL) counter and bad block indicator for the physical block ‘PBK#’ at 736. The process 700 moves to decision 738, in which it is determined whether the stored information is in conflict with the physical state of ‘PBK#’. If ‘yes’, the process 700 corrects the conflict information to be consistent with the physical state in the scratch memory at 740. If ‘no’ at decision 738, there is no need to correct the conflict.

Next, at 742, the physical block counter ‘PBK#’ is incremented by one. The process 700 moves to another decision 744, it is determined if there is additional block in the ‘m^{th}’ group. If ‘yes’, the process 700 goes back to step 736 reading another WL counters of another physical block to repeat the above steps until the decision 744 becomes ‘no’. The process 700 updates the stored WL/BB tracking table 310 at 746. At next decision 748, it is determined if there is any more physical block. If ‘yes’, the process 700 increments the group counter at 749 then goes back to 734 for repeating the above steps for another group. Otherwise, the step 730 returns when the decision 748 is ‘no’.

FIG. 7D shows details of step 750, which is substantially similar to the step 730. Instead of checking and correcting conflict WL/BB information, the step 750 validates and corrects the stored error correction code (ECC) for all physical blocks. The number of group is related to the size of the scratch memory. For example, a 2048-byte page buffer can provide space for holding a group of 1024 WL counters, if each of the WL counters is a 16-bit number. As to the 8-bit ECC, the same 2048-byte page buffer may hold a group of 2048 ECC codes.

FIG. 7E shows details of step 770. At 772, the process 700 initializes a logical block counter ‘LBK#’ and a group counter ‘k’ to zero. The process 700 loads a ‘k^{th}’ group of stored PLTPPUI into a scratch memory space (e.g., a page buffer or other available memory) at 774. The process 700 reads logical block address from the spare area of the first page of a physical block corresponding to the ‘LBK#’ at 776. Next, at decision 778, it is determined whether there is conflict between the stored PLTPPUI and the physical page usage of the physical block. If ‘yes’, the conflict is corrected with the physical state in the scratch memory at 780. Otherwise, the process 700 skips step 780. Next, at 782, the process 700 increments the logical block counter ‘LBK#’ by one. The process 700 then moves to another decision 784, in which it is determined if there is more block in the ‘k^{th}’ group. If ‘yes’, the process 700 moves back the step 776 repeating the process until the decision 784 becomes ‘no’. Then the process 700 updates the stored PLTPPUI records if the scratch memory has been altered at 786. Next, at decision 788, if there is more logical block, the process 700 follows the ‘yes’ branch to step 789 by incrementing the group counter and repeating the process from step 774 until the decision 788 becomes ‘no’, in which the step 770 ends.

Each entry record of PLTPPUI is 18-byte, which is a sum of 2-byte physical block number plus 128-bit (i.e., 16-byte) of page usage flags (i.e., 128 pages per block). Using 2048-byte page buffer as a scratch memory can only hold a group of 113 entry records. One may use a larger memory such as ACPUM 306 as the scratch memory, which may hold more entry records thereby reducing the initialization time.

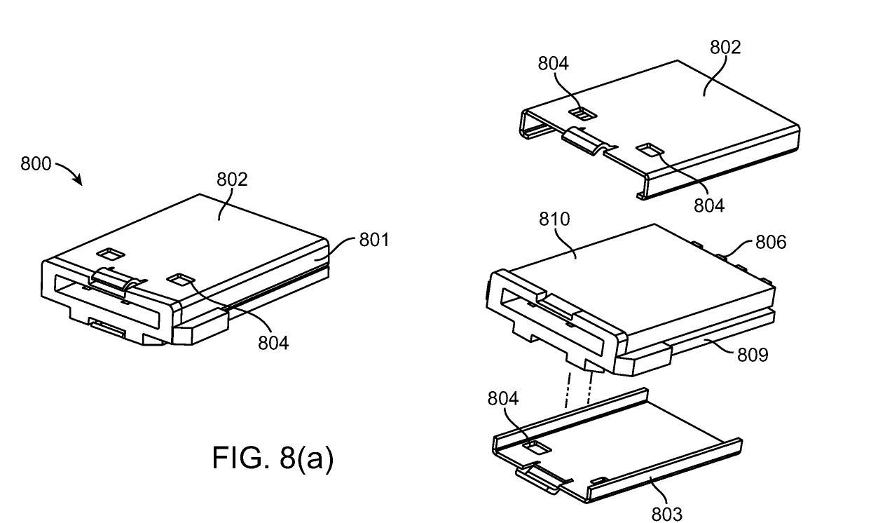

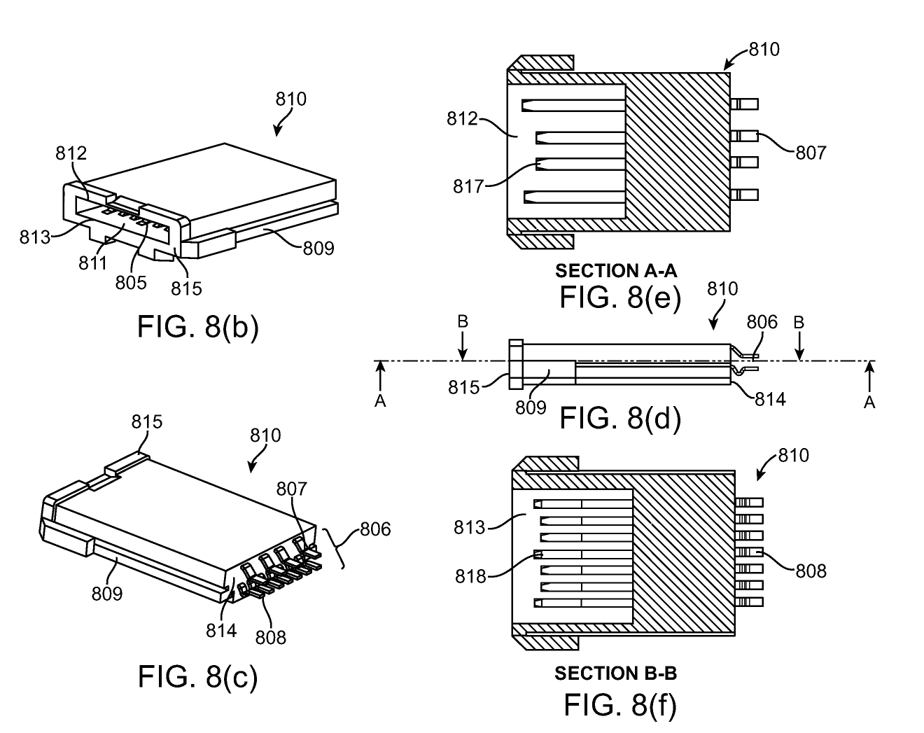

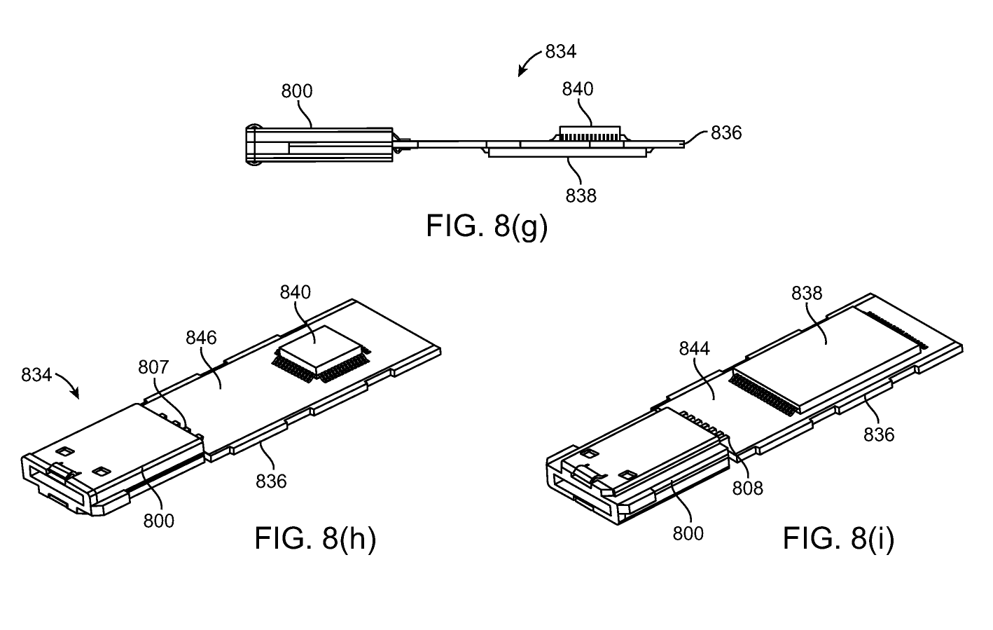

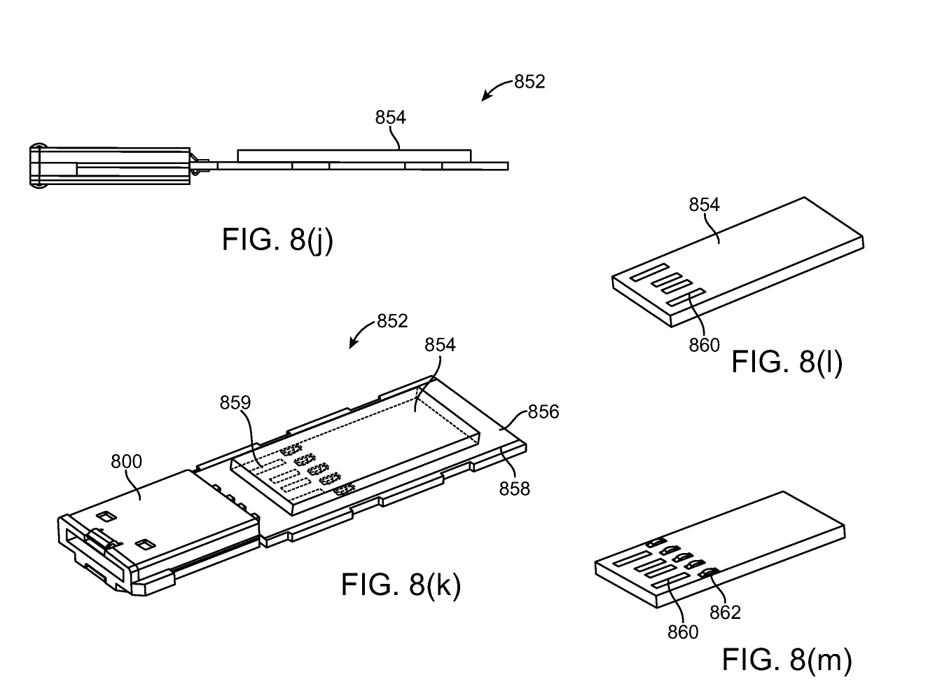

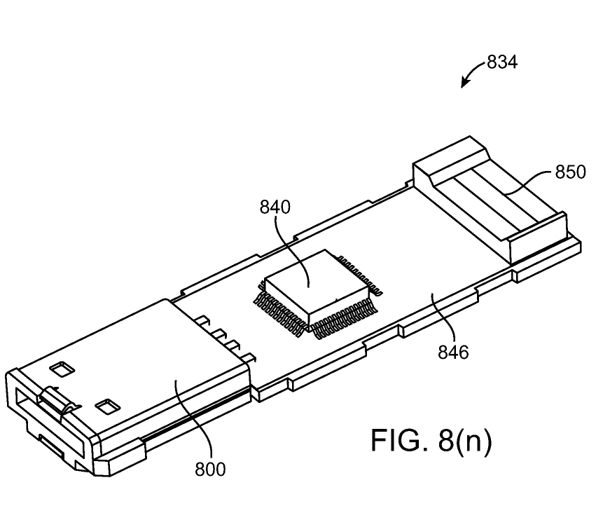

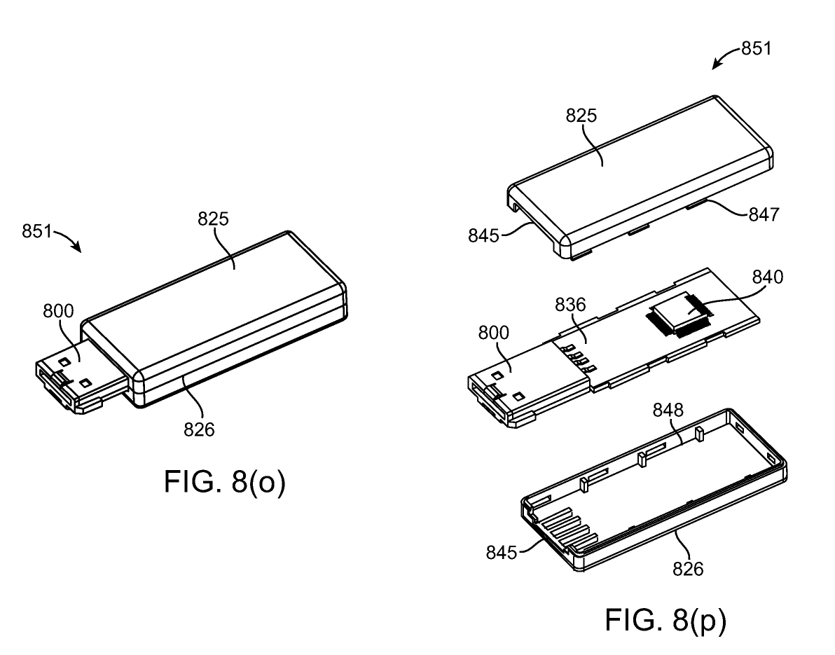

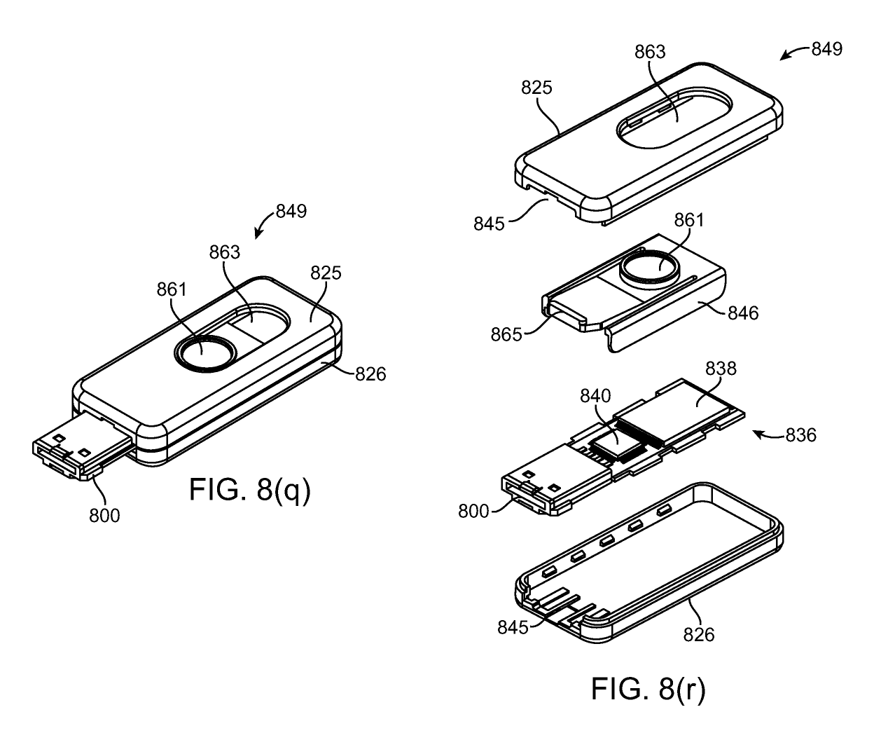

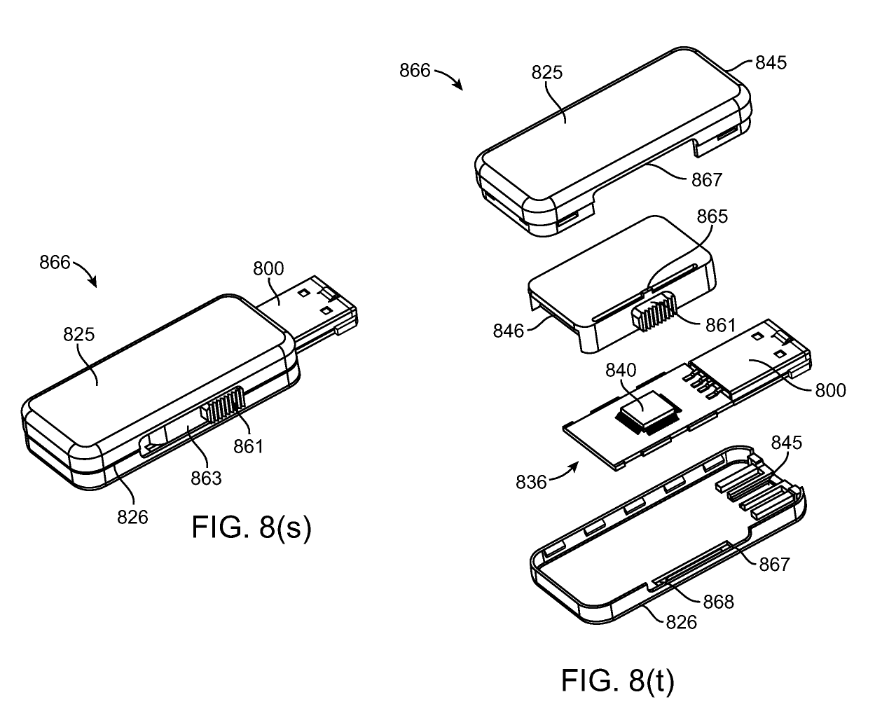

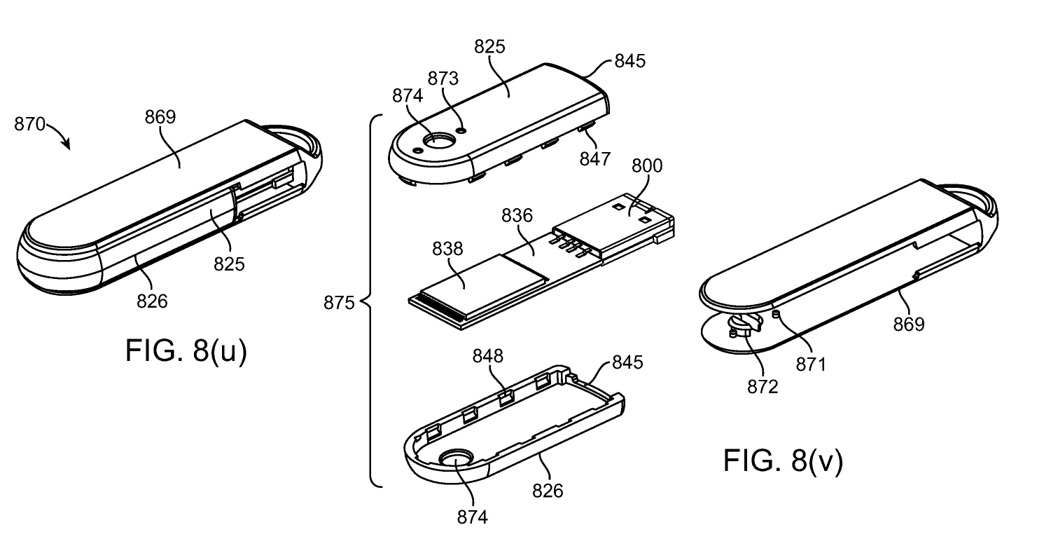

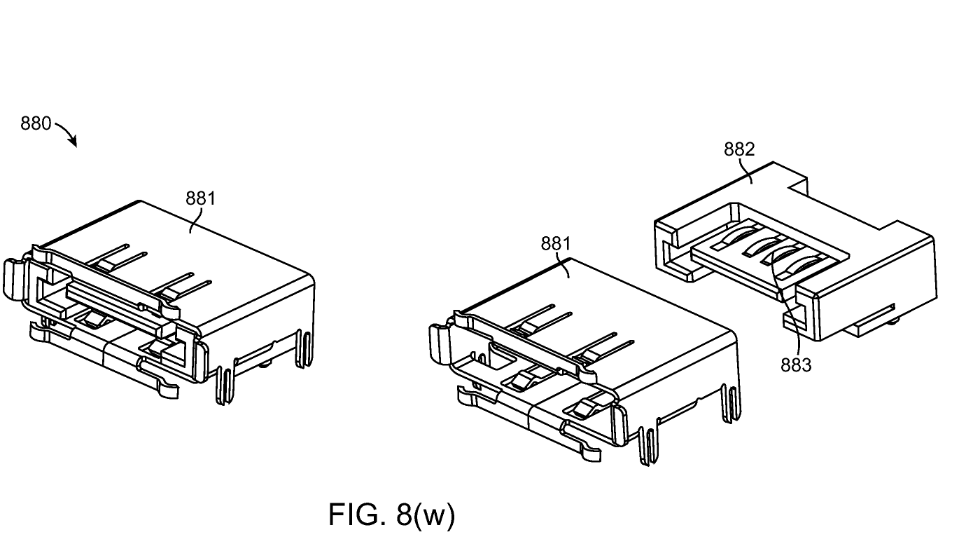

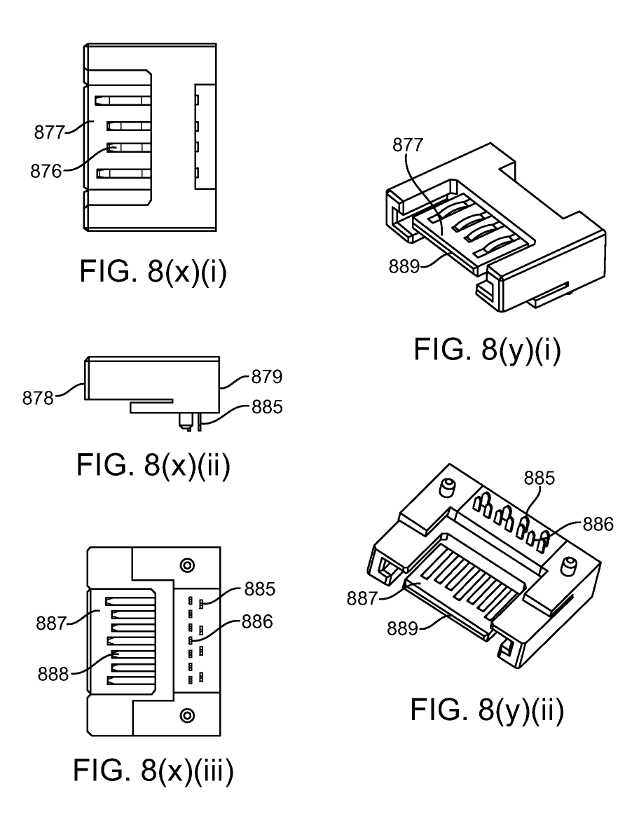

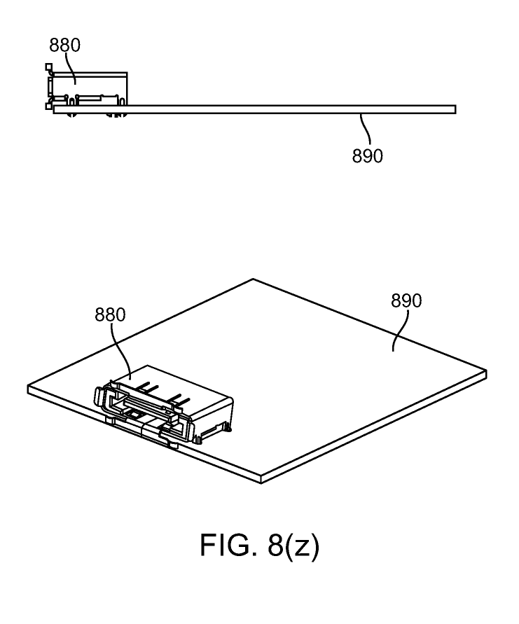

FIGS. 8(a)-8(z) collectively show various perspective views and exploded perspective views of a dual-personality Extended External Serial Advanced Technology Attachment (eSATA) plug connector 800 of a flash memory device, in accordance with several embodiments of the present invention.

The flash memory device of which the plug connector 800 is a part of a flash memory device analogous to the flash memory device of FIG. 1A. The flash memory device has higher memory density, faster transfer rates, MLC-compatibility, and an extended eSATA plug connector with more pins and more contact fingers than prior art eSATA connectors. The plug connector 800 generally includes 11 pins which accommodate interfacing with a dual-personality extended eSATA receptacle connector (11 pins) or a standard eSATA receptacle connector (7 pins). If the plug connector 800 is to interface with a standard eSATA receptacle connector only 7 pins (SATA standard) are applicable; the 4 pins (USB standard) are not applicable. A flash drive 834 (shown in subsequent figures) and a host (not shown) transfer electrical data there between through the plug connector 800 and a receptacle connector and in doing so, the flash drive 834 can selectively transfer data in compliance with the SATA standard and with an optional USB standard (extended).

The plug connector 800 contains a first row of four pins thereby making interface with industry standard USB (extended), and a second row of seven pins thereby making interface with eSATA (standard).

FIG. 8(a) shows a perspective view of a dual-personality extended eSATA plug connector 800, in accordance with an exemplary embodiment of the present invention. The plug connector 800 is shown to be a three-dimension rectangle. The plug connector 800 is encapsulated by a top cover 802 and a bottom cover 803 that join together to form housing 801. Disposed on both top cover 802 and bottom cover 803 are metal holes 804. The holes 804 are shown disposed substantially on a side opposite to pins 806 and aligned with respect to each other. A connector substrate 810 is disposed inside of the connector 800. Disposed substantially on each of the vertical sides of substrate 810 are side tracks 809. Side tracks 809 serve to align the plug connector 800 securely within the dual-personality extended eSATA receptacle connector 880. The substrate has connected thereto the pins 806 for establishing electrical connection between the connector 800 and the printed circuit board (PCB). The connector 800 is in conformance with the industry-adopted eSATA standard.

FIG. 8(b) shows a front perspective view of connector substrate 810. The substrate 810 is shown to include connector substrate front end 815, connector substrate back end 814, receptacle cavity 811, receptacle cavity top surface 812, receptacle cavity bottom surface 813, contact fingers 805 and side tracks 809. Not shown in FIG. 8(b), but located on the side substantially opposite receptacle cavity 811 are pins 806. Receptacle cavity 811 is shown disposed on connector substrate front end 815. Receptacle cavity 811 is shown to further include receptacle cavity top surface 812 and receptacle cavity bottom surface 813. Shown inside receptacle cavity 811 are contact fingers 805. Contact fingers 805 include USB contact fingers 817 and SATA contact fingers 818. Each contact finger 805 corresponds with a pin 806 so that when the contact fingers 805 of connector 800 makes electrical contact with the SATA contact fingers 888 or the USB contact fingers 876 of the dual-personality extended eSATA receptacle connector 880, an electrical connection is made between the host and the PCB 836 of the flash drive 834.

FIG. 8(c) shows a back perspective view of connector substrate 810. The substrate 810 is shown to include substrate front end 815, substrate back end 814, side tracks 809, pins 806, first row pins 807 and second row pins 808. Not shown in FIG. 8(c) but included within substrate 810 are receptacle cavity top surface 812, receptacle cavity bottom surface 813, receptacle cavity 811, and contact fingers 805. Pins 806 are shown to extend outwardly from substrate back end 814. Pins 806 are shown to be further comprised of first row pins 807 and second row pins 808. First row pins 807 comprise of 4 individual pins which utilize the industry-adopted USB standard. Second row pins 808 comprise of 7 individual pins which utilize the eSATA standard.

FIG. 8(d) shows a side perspective of connector substrate 810. Substrate 810 is shown to include substrate front end 815, substrate back end 814, side tracks 809, and pins 806. Substrate 810 is shown bisected by a center line. FIG. 8(e) shows a section view of substrate 810 above the center line, while FIG. 8(f) shows a section view of substrate 810 below the center line.

FIG. 8(e) shows a section view of connector substrate 810 above the center line. This view shows only the USB compliant contact fingers and pins. Substrate 810 is shown to include receptacle cavity top surface 812, first row pins 807, and USB contact fingers 817. USB contact fingers 817 contain 4 individual contact fingers, which are disposed on receptacle cavity top surface 812. The USB contact fingers 817 and SATA contact fingers 818 are situated relative to one another in a manner so that their individual contact fingers are spaced apart in an interleaved fashion thereby allowing the rows to make electrical contact with a mating connector of a host to which electrical contact is intended.

FIG. 8(f) shows a section view of connector substrate 810 below the center line. This view shows only the SATA compliant contact fingers and pins. Substrate 810 is shown to include receptacle cavity bottom surface 813, second row pins 808, and SATA contact fingers 818. SATA contact fingers 818 contain 7 individual contact fingers, which are disposed on receptacle cavity bottom surface 813.

Referring to FIG. 8(g), a perspective side view of a dual-personality extended eSATA flash drive 834 to which the connector 800 is connected, is shown in accordance with an embodiment of the present invention. The flash drive 834 is shown to include a printed circuit board assembly (PCBA) 836 with the connector 800 connected thereto. The connector 800 is shown disposed on the top surface of PCBA 836. PCBA 836 is shown to have a MLC flash controller integrated circuit (IC) 840 mounted on the top surface thereof, and a MLC flash memory IC 838 mounted on the bottom surface thereof. The connector 800 is coupled to the PCBA 836 electrically and physically such that control signals and power can pass therethrough. It is noted that the MLC memory IC 838 may include one or more ICs and/or memory substrates.

In an exemplary application, a special design for industrial and military application on the finished assembly of the flash drive 834 includes a conforming coating to achieve the purposes of preventing oxidation of integrated circuit leads or soldering area; covering or protecting extreme temperature exposure either cold or hot; and waterproofing for certain military or industrial applications. The procedure of applying the conforming coating to the flash memory device includes: 1) placing a masking cap or tape on specific area(s) such as connectors, switches; 2) spraying or brushing the conforming coating material (e.g., HumiSeal® 1B73); and 3) inspecting the coated area with ultraviolet (UV) lights for imperfection (e.g., bubbles, missed coating area).

PCBA 836 is generally used for mechanically supporting and electrically connecting electronic components using conductive pathways, or traces, etched from copper sheets laminated onto a non-conductive substrate. The core unit is also referred to as a print circuit board assembly (PCBA).

FIG. 8(h) shows a perspective top view of the flash drive 834 including the connector 800, MLC controller IC 840, PCB 836, and first row pins 807. The MLC controller IC 840 are shown mounted on a PCBA top surface 846. The first row pins 807 of the connector 800 are shown physically connected to the PCBA top surface 846 causing electrical coupling of the connector 800 to the PCBA 836.

FIG. 8(i) shows a perspective bottom view of the flash drive 834. The MLC memory IC 838 is shown mounted on a PCBA bottom surface 844 of the flash drive 834. The second row pins 808 of the connector 800 are shown physically connected to the PCBA bottom surface 844 causing electrical coupling of the connector 800 to the PCBA 836.

FIGS. 8(j) through 8(m) show various perspective views of an extended dual-personality eSATA flash drive 852, in accordance with another embodiment of the present invention. FIG. 8(j) shows a side perspective view of the flash drive 852, which is shown to have an MLC Multi-Level-Cell COB Chip-On-Board 854, replacing the MLC controller IC 840 and memory IC 838 of the flash drive 834.

Fig. (k) shows a perspective top view of the flash drive 852. The COB 854 is mounted onto a PCBA top surface 856 of a PCBA 858, which is analogous to the PCBA 836. The COB 854's bottom surface has COB contact fingers 859, which are soldered to PCB top surface 856. The COB contact fingers 859 comprise the first row COB contact fingers 860 and the second row COB contact fingers 862. Two different COB contact finger configurations are formed onto the COB 854. In one embodiment, shown in FIG. (1), a standard configuration includes a first row COB contact fingers 860. In another embodiment, a second row COB contact fingers 822 is used in combination with the first row, as shown in FIGS. 8(k) and 8(m). The first row configuration, e.g. FIG. 8(1), is sometimes referred to as a standard COB and used for USB interfacing. The first and second row configuration is sometimes referred to as an extended COB. The first row COB contact fingers 860 has four contact fingers for USB interface and the second row COB contact fingers 862 has five contact fingers for extended interface. The COB in FIG. 8(m) is referred to as extended COB 860.

Referring now to FIG. 8(n), the flash drive 834 is shown to include a fingerprint capability, in accordance with an alternative embodiment of the present invention. The flash drive 834 is shown to include a printed circuit board assembly (PCBA) 836 with the connector 800 connected thereto. The connector 800 is shown disposed on the top surface of PCBA 836. PCBA 836 is shown to have a MLC flash controller integrated circuit (IC) 840 mounted on the top surface 846 thereof. Not shown in FIG. 8(n) is MLC flash memory IC 838 mounted on the bottom surface of PCBA 836. The flash drive 834 optionally includes a fingerprint sensor 850 mounted on the PCBA top surface 846, at end of the flash drive 834 that is in opposite to the connector 800. It is understood that the fingerprint sensor 850 may be placed on the PCBA bottom surface 844 or any other location on the flash drive 834 that is suitable for the fingerprint sensor 850 to be located thereon. In operation, a user of the flash drive 834 slides or swipes a finger, which is intended to have its print recorded and used in association with the drive, on the surface thereof. For example, a user's finger slides in a direction towards connector 800 for authentication, and a user's finger slides in an opposite direction (away from the connector 800) for recording the user's fingerprint. The same is done when authenticating or confirming the user's fingerprint. The fingerprint sensor 850 is physically connected to the PCBA 836 and electrically coupled to the electronic components connected to the PCBA 836, such as the controller IC 840. U.S. patent application Ser. No. 12/099,421 offers greater details regarding the fingerprint sensor 850.

Referring to FIG. 8(o), the flash drive 851 is shown enclosed inside a upper housing 825 and bottom housing 826 to protect the PCBA 836 from exposure from the outside environment. In this alternative embodiment both the housings are rectangular in shape. It is contemplated by those skilled in the art that alternative housing shapes, for example a square housing shape, are possible. The upper housing 825 and bottom housing 826 are put together by either snap-together mechanism or ultrasonic welding around the edges of the housing. Each of the upper and bottom housing includes a cut out to allow the plug connector to be exposed external to the housing for use.

FIG. 8(p) shows an exploded view of flash drive 851. Flash drive 851 is shown to include upper housing 825, PCBA 836, and bottom housing 826. Upper housing 825 is shown to include connector cut-out 845 and upper snap coupling tabs 847. Tabs 847 are disposed on the lateral sides of upper housing 825. Upper snap coupling tabs 847 are shown to be arranged in a rectangular saw-toothed pattern. The saw-toothed pattern as shown on upper snap coupling tabs 847 is complementary with those of lower snap coupling slots 848. Complementary, as defined herein, indicates a repeating pattern of rectangular blocks and gaps which fit generally snugly together when pressed against its corresponding partner repeating pattern. Similarly, bottom housing 826 is shown to include connector cut-out 845 and lower snap coupling slots 848. Slots 848 are disposed upon the lateral sides of lower housing 826. PCBA 836 is shown to include connector 800 and MLC controller IC 840. Not shown in FIG. 8(p) is MLC flash memory IC 838 mounted on the bottom surface of PCBA 836. In one embodiment of the present invention the upper housing 825 and lower housing 826 are joined together by a snap-together mechanism. In an alternative embodiment of the present invention, ultrasonic welding around the edges of the housing join the upper housing 825 and lower housing 826 together.

FIG. 8(q) shows press/push flash drive 849 in accordance with an embodiment of the present invention. Flash drive 849 is comprised of connector 800, upper housing 825, lower housing 826, slide button 861, and slide button opening 863. In FIG. 8(q), the press/push flash drive 849 is shown with the connector 800 exposed. Located substantially central to the external face of the upper housing 825 is the slide button 861. Slide button 861 operates within the plane of upper housing 825, and when force is applied down into the press/push flash drive 849 and in the direction toward the metal connector 800 using, for example, a finger, slide button 861 slides uniaxially along the external face of upper housing 825, extending the connector 800, in one embodiment of the present invention.

FIG. 8(r) shows an exploded perspective of flash drive 849. Flash drive 849 is comprised of upper housing 825, core unit carrier 846, PCBA 836, and lower housing 826. Upper housing 825 is shown to include slide button opening 863 and connector cut-out 845. Core unit carrier 846 is shown to include slide button 861 and lock tab 865. Lock tab 865 works in concert with lock grooves 868 (not shown in FIG. 8(r)) to lock the plug connector 800 at deployed and retracted positions. The core unit carrier 846 fits substantially securely underneath upper housing 825. PBCA 836 is shown to include connector 800, MLC controller IC 840, and MLC memory IC 838. It is noted that PCBA 836 may include one or more MLC memory IC's 838. The PCBA 836 is secured between upper housing 825 and bottom housing 826. Bottom housing 826 is shown to include connector cut-out 845. Connector cut-outs 845 disposed on both upper housing 825 and lower housing 826 allow connector 800 to be extended externally and withdrawn into the housing.

The upper housing 825 and bottom housing 826 may be attached to each other via variety of method, including using a snap-together mechanism or ultrasonic welding around edges of upper housing 825 and bottom housing 826. The plug connector 800 is coupled to the PCBA 836 electrically and physically such that control signals and power can pass through. U.S. patent Application Ser. No. 11/845,747, Filed Aug. 27, 2007 entitled: “PRESS/PUSH USB FLASH DRIVE WITH DEPLOYING AND RETRACTING FUNCTIONALITIES WITH ELASTICITY MATERIAL AND FINGERPRINT VERIFICATION CAPABILITY” offers greater details regarding the press/push flash drive 849.

FIG. 8(s) shows a perspective view of press/push flash drive 866 in accordance with yet another embodiment of the present invention. Flash drive 866 is shown to include connector 800, upper housing 825, lower housing 826, slide button 861, and slide button opening 863. In FIG. 8(s), the press/push flash drive 866 is shown with the connector 800 exposed. Located substantially central on the side of flash drive 866, where upper housing 825 and bottom housing 826 join, is slide button 861. Slide button 861 operates when force is applied to the slide button 861 along the side of the press/push flash drive 849 and in the direction toward the metal connector 800 using, for example, a finger. With force slide button 861 slides forward toward the connector 800, extending the connector 800. Similarly, when force is applied upon slide button 861 in the direction opposite connector 800 the connector 800 retracts back inside flash drive 866.

FIG. 8(t) shows an exploded perspective of flash drive 866. Flash drive 866 is comprised of upper housing 825, core unit carrier 846, PCBA 836, and lower housing 826. Upper housing 825 is shown to include slide button cut-out 867 and connector cut-out 845. Core unit carrier 846 is shown to include slide button 861 and lock tab 865. Lock tab 865 works in concert with lock grooves 868 (disposed on lower housing 826 and upper housing 825 (not shown)) to lock the plug connector 800 at deployed and retracted positions. The core unit carrier 846 fits substantially securely underneath upper housing 825, positioned such that slide button 861 is exposed between the slide button cut-outs 867. PCBA 836 is shown to include connector 800 and MLC controller IC 840. Not shown in FIG. 8(t) is MLC memory IC 838 which is disposed on the underside of PCBA 836. It is noted that PCBA 836 may include one or more MLC memory IC's 838. The PCBA 836 is secured between upper housing 825 and bottom housing 826. Bottom housing 826 is shown to include side button cut-out 867, lock grooves 868, and connector cut-out 845. Connector cut-outs 845 disposed on both upper housing 825 and lower housing 826 allow connector 800 to be extended externally and withdrawn into the housing.

The upper housing 825 and bottom housing 826 may be attached to each other via variety of method, including using a snap-together mechanism or ultrasonic welding around edges of upper housing 825 and bottom housing 826. The plug connector 800 is coupled to the PCBA 836 electrically and physically such that control signals and power can pass through. U.S. patent application Ser. No. 11/845,747, Filed Aug. 27, 2007 entitled: “PRESS/PUSH USB FLASH DRIVE WITH DEPLOYING AND RETRACTING FUNCTIONALITIES WITH ELASTICITY MATERIAL AND FINGERPRINT VERIFICATION CAPABILITY” offers greater details regarding the press/push flash drive 866.

The deploying and retracting the USB plug connector out of and into the housing plus the locking mechanism between the lock tabs (core unit carrier) and the lock grooves (housing) are described in details in a co-pending of U.S. patent application Ser. No. 11/845,747, filed Aug. 27, 2007.

FIG. 8(u) shows a side perspective view of locking swivel cap flash drive 870. Flash drive 870 is shown to include upper housing 825, bottom housing 826, and swivel cap 869. The swivel cap 869 rotates around the flash drive, and locks in an open position at substantially 180 degrees, and locks in a closed position at substantially 0 degrees.

FIG. 8(v) shows an exploded view of locking swivel cap flash drive 870. Flash drive 870 is shown to include upper housing 825, PCBA 836, bottom housing 826, and swivel cap 869. Top housing 825 is comprised of lock holes 873, pivot hole 874, connector cut-out 845, and upper snap coupling tabs 847. The pivot hole houses the pivot pin 872 when the swivel cap 869 is joined with the flash drive unit 875, comprising of the PCBA 836 covered with upper housing 825 and bottom housing 826. The PCBA 836 is shown to include connector 800 and MLC memory IC 838. Not shown in FIG. 8(v) is MLC controller IC 840, disposed of on the underside of PCBA 836. The lower housing 826 is shown to include connector cut-out 845, pivot hole 874, and lower snap coupling slots 848. Upper housing 825 and bottom housing 826 are joined substantially securely together when upper snap coupling tabs 847 and lower snap coupling slots 848 come together using a snap-together mechanism. The saw-toothed pattern as shown on upper snap coupling tabs 847 is complementary with those of lower snap coupling slots 848.

Swivel cap 869 is shown to include pivot pin 872 and lock pins 871. The swivel cap 869 rotates around the pivot pin 872. The lock pins 871 rotate within the swivel cap 869, where the lock pins 871 lock into the lock holes 873 and the at both a substantially 180 degree (“open position”) and substantially 0 degree (“closed position”). That is, the lock pins 871 snap into the holes 873 when the swivel cap 869 is rotated, and serve to lock the USB flash drive 870 in the open or closed position. When the USB flash drive 870 is locked in the closed position, the connector 800 and PCBA 836 is fully enclosed within the swivel cap 869 to protect the flash drive 870 from physical damage. When the flash drive 870 is locked in the open position, the connector 800 is fully exposed for operation. In ordinary use, flash drive unit, comprising of the PCBA 836 covered with upper housing 825 and bottom housing 826, and swivel cap 869 are permanently attached to each other, preventing the swivel cap 869 from being misplaced. U.S. patent application Ser. No. 11/929,857 filed Oct. 30, 2007 entitled: “UNIVERSAL SERIAL BUS (USB) FLASH DRIVE HAVING LOCKING PINS AND LOCKING GROOVES FOR LOCKING SWIVEL CAP” offers greater detail regarding the swivel cap flash drive.

FIG. 8(w) shows a side perspective view of the dual-personality extended eSATA receptacle connector 880. Receptacle connector 880 is shown to be comprised of metal cover 881 and connector substrate 882. Metal cover 881 is shown to be a three-dimension rectangle. Metal cover 881 substantially encloses the four sides of the connector substrate 882 while leaving the contact fingers 883 of substrate 882 accessible for interfacing with plugs. Receptacle connector 880 can advantageously interface with the dual-personality extended eSATA plug connector of FIG. 8(a), as well as standard USB or eSATA plug connectors.

FIG. 8(x)(i) shows a top view of connector substrate 882. Connector substrate 882 is shown to include USB contact fingers 876 and center island top surface 877. USB contact fingers 876 include 4 individual contact fingers, in conformity with the USB standard. The USB contact fingers 876 are disposed along the center island top surface 877.

FIG. 8(x)(ii) shows a side view of connector substrate 882. Connector substrate 882 is shown to include substrate front end 878, substrate back end 879, and first row pins 885, and back row pins 886 (not shown).

FIG. 8(x)(iii) shows a bottom view of connector substrate 882. Connector substrate 882 is shown to include SATA contact fingers 888 and center island bottom surface 887. SATA contact fingers 888 include 7 individual contact fingers, in conformity with the SATA standard. The SATA contact fingers 888 are disposed along the center island bottom surface 887. When a USB or SATA connector is plugged into the dual-personality extended eSATA receptacle connector 880, no selection mechanism need be used to select a particular type of available connection, i.e. USB or SATA. If USB is present, then no electrical connection will be made with the SATA contact fingers 888. If SATA is present, no electrical connection will be made with the USB contact fingers 876.

FIG. 8(y)(i) shows a top side perspective view of connector substrate 882. Connector substrate 882 is shown to include center island top surface 877 and center island 889. Disposed on center island top surface are USB contact fingers 876.

FIG. 8(y)(ii) shows a bottom side perspective view of connector substrate 882. Connector substrate 882 is shown to include center island bottom surface 887, center island 889, first row pins 885, and back row pins 886. The center island 889 is operative to slide into the receptacle cavity of the connector 800 when the plug and receptacle are interfaced with each other. The back end of the connector substrate 879 has 2 rows of pins for PCB interface. The first row pins 885 have 4 pins in conformity with the USB standard, and the back row pins 886 has 7 pins in conformity with the SATA standard.

FIG. 8(z) shows a side view and a top perspective view of receptacle connector 880 attached to mother board PCBA 890. Inside the chassis of the host system, a cable assembly with one end with a receptacle connector and one end with a plug connector is operative to establish a communication link between the flash memory device and the motherboard. One end of the cable with the receptacle connector is mounted and exposed through the host system's chassis and connected to the plug connector 800 and the other end of the cable with a plug connector is coupled with the motherboard PCBA 890 with the receptacle connector 880 as shown in FIG. 8(z).

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable medium. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas the size of the data area of a page has been shown to hold four sectors of 512-data, a page holds other number of sectors such as eight may be used. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A multi-level cell (MLC) dual-personality extended External Serial Advanced Technology Attachment (eSATA) flash drive comprising:
A dual-personality extended eSATA plug connector connected to a MLC flash drive and removably connectable to a host, the connector being selectably adapted to interface with either an extended eSATA receptacle connector or a standard eSATA receptacle connector.

2. A flash drive, as recited in claim 1, wherein said MLC extended dual-personality eSATA plug connector has disposed thereon a first row of contact fingers compliant with the USB standard, and a second row of contact fingers compliant with the SATA standard.

3. A flash drive, as recited in claim 2, wherein said MLC extended dual-personality eSATA plug connector has disposed thereon a first row of four contact fingers and a second row of 7 contact fingers.

4. A flash drive, as recited in claim 2, wherein said MLC extended dual-personality eSATA plug connector has disposed thereon a first row of pins compliant with the USB standard, and a second row of pins compliant with the SATA standard, and operative to facilitate an electrical connection between a host and the printed circuit board (PCB) of said flash drive.

5. A flash dive, as recited in claim 4, wherein said MLC extended dual-personality eSATA plug connector has disposed thereon a first row and a second row of pins, each operative to receive electrical data.

6. An extended dual-personality eSATA receptacle connector having disposed thereon a top row of contact fingers compliant with the USB standard, and a bottom row of contact fingers compliant with the SATA standard.

7. An extended dual-personality eSATA receptacle connector, as recited in claim 6, wherein said connector has disposed thereon a top row of four contact fingers and a bottom row of seven contact fingers.

8. An extended dual-personality eSATA receptacle connector, as recited in claim 6, wherein said connector has disposed thereon a first row of pins compliant with the USB standard, and a second row of pins compliant with the SATA standard, and operative to facilitate an electrical connection between a host and the printed circuit board (PCB) of said flash drive.

9. An extended dual-personality eSATA receptacle connector, as recited in claim 8, wherein said connector has disposed thereon a first row and a second row of pins, each operative to receive electrical data.

10. A flash drive as recited in claim 1 further comprising a fingerprint sensor mounted on one end thereof, and operative to authenticate and confirm the user's fingerprint.

11. A flash drive as recited in as recited in claim 2, further including a housing formed from upper and bottom housings joined together to substantially encapsulate said flash drive, while leaving the plug connector exposed.

12. A flash drive as recited in as recited in claim 5, further including a printed circuit board assembly (PCBA) connected to the plug connector operative to store the received electrical data and encapsulated by said housing.

13. A flash drive as recited in claim 12, further comprising:
an upper housing having a top surface and lateral sides descending from said top surface, a front opening located within one of said lateral sides, a top slide button opening located on said upper housing, a slide button and a lock tab located on a core unit carrier, wherein said core unit carrier rests below said upper housing and said slide button is exposed and accessible through said top slide button opening, and a deployed and retracted lock grooves formed on the underside of the upper housing surface; and
a bottom housing having a bottom surface and lateral sides descending from said bottom surface, a front opening located within one of said lateral sides, the bottom housing connected to said upper housing, together the upper housing and bottom housing thereby including within, a printed circuit board assembly (PCBA), with the front openings of the upper housing and bottom housing aligned, forming an opening on one end of the coupled housings,
wherein pressing and pushing said slide button of said flash drive in the direction of the opening on one end of the housings extends a connector plug for interfacing the flash drive with an electronic device and said lock tab of said flash drive become secured within said lock grooves of the upper housing, and pressing and pushing said slide button in the direction opposite of the opening on one end of the housings retracts the connector plug and said lock tabs become secured within said lock grooves of the upper housing.

14. A flash drive as recited in claim 12, further comprising:
an upper housing with a top surface and lateral sides descending from said top surface, a front opening located within one of said lateral sides, and deployed lock grooves and retracted lock grooves formed on the inside of the top surface, the deployed lock grooves located closer to the front opening than the retracted lock grooves; and
a bottom housing with a bottom surface and lateral sides descending from said bottom surface, a front opening located within one of said lateral sides, the bottom housing coupled with said upper housing, together the upper housing and bottom housing thereby containing within, a printed circuit board assembly (PCBA), with the front openings of the upper housing and bottom housing aligned, forming an opening on one end of the coupled housings,
wherein pressing and pushing said press/push button of said flash drive in the direction of the opening on one end of the housings extends a connector plug for interfacing said flash drive with an electronic device and said lock tab of said flash drive become secured within said lock grooves of the upper housing, and pressing and pushing said press/push button in the direction opposite of the opening on one end of the housings retracts the connector plug and said lock tab become secured within said lock grooves of the upper housing.

15. A flash drive as recited in claim 12, further comprising:
a swivel cap;
a pivot pin where said swivel cap attaches to said flash drive thereby allowing the swivel cap to rotate substantially into a first and a second locking position and rotate around said flash drive; and
lock pins disposed on the top and bottom sides of the swivel cap and operative to lock and unlock the swivel cap in place, wherein the swivel cap locks substantially in a first locking position and a second locking position, wherein the locking and unlocking design requires the lock pins to raise up and out of lock holes to rest on upper and bottom housings when unlocked, and descend downward until the lock pins rest in the lock holes when locked.

16. A multi-level cell (MLC) dual-personality extended External Serial Advanced Technology Attachment (eSATA) flash drive comprising:
connector means for connection to a host; and
means connected to the connector means for selectably receiving electrical data from either a USB or a eSATA interface.

17. A flash drive as recited in claim 16, further comprising means for facilitating an electrical connection between a host and the printed circuit board (PCB) of said flash drive.

18. A flash drive as recited in claim 16, further comprising means for authenticating and confirming the user's fingerprint.

19. A flash drive as recited in claim 16, further comprising means for joining together and substantially encapsulating said flash drive, while leaving the plug connector exposed.

20. A flash drive as recited in claim 16, further comprising:
connector means for connection to a plug connector; and
means connected to the connector means for storing the received electrical data.

21. A flash drive as recited in claim 20, further comprising:
upper housing means having a top surface and lateral sides descending from said top surface, a front opening located within one of said lateral sides, a top slide button opening located on said upper housing, a slide button and a lock tab located on a core unit carrier, wherein said core unit carrier rests below said upper housing and said slide button is exposed and accessible through said top slide button opening, and deployed and retracted lock grooves formed on the underside of the upper housing surface; and
a bottom housing means having a bottom surface and lateral sides descending from said bottom surface, a front opening located within one of said lateral sides, the bottom housing connected to said upper housing, together the upper housing and bottom housing thereby including within, a printed circuit board assembly (PCBA) means having the front openings of the upper housing and bottom housing aligned, forming an opening on one end of the coupled housings,
wherein pressing and pushing said slide button of said flash drive in the direction of the opening on one end of the housings extends a connector plug for interfacing the flash drive with an electronic device and said lock tab of said flash drive become secured within said lock grooves of the upper housing, and pressing and pushing said slide button in the direction opposite of the opening on one end of the housings retracts the connector plug and said lock tab become secured within said lock grooves of the upper housing.

22. A flash drive as recited in claim 20, further comprising:
an upper housing means with a top surface and lateral sides descending from said top surface, a front opening located within one of said lateral sides, and deployed lock grooves and retracted lock grooves formed on the inside of the top surface, the deployed lock grooves located closer to the front opening than the retracted lock grooves; and
a bottom housing means with a bottom surface and lateral sides descending from said bottom surface, a front opening located within one of said lateral sides, the bottom housing coupled with said upper housing, together the upper housing and bottom housing thereby containing within, a printed circuit board assembly (PCBA), with the front openings of the upper housing and bottom housing aligned, forming an opening on one end of the coupled housings,
wherein pressing and pushing said press/push button of said flash drive in the direction of the opening on one end of the housings extends a connector plug for interfacing said flash drive with an electronic device and said lock tab of said flash drive become secured within said lock grooves of the upper housing, and pressing and pushing said press/push button in the direction opposite of the opening on one end of the housings retracts the connector plug and said lock tab become secured within said lock grooves of the upper housing.

23. A flash drive as recited in claim 20, further comprising:
a swivel cap means to cover and uncover the plug connector;
a pivot pin means connected to the swivel cap means attached to said flash drive thereby allowing the swivel cap to rotate substantially into a first and a second locking position and rotate around of said flash drive; and
lock pins means disposed on the top and bottom sides of the swivel cap and operative to lock and unlock the swivel cap in place, wherein the swivel cap locks substantially in a first locking position and a second locking position, wherein the locking and unlocking design requires the lock pins to raise up and out of lock holes to rest on upper housing when unlocked, and descend downward until the lock pins rest in the lock holes when locked.

24. A method of selectively interfacing a multi-level cell (MLC) dual-personality extended External Serial Advanced Technology Attachment (eSATA) flash drive to a host comprising:
Providing a top row of four USB contact fingers of MLC dual-personality extended eSATA plug connector that is removably connectable to a host;
Providing a second row of seven eSATA contact fingers of MLC dual-personality extended eSATA plug connector;
Selectively using either the first row or the second row to interface the flash drive with a host.
